(19) United States
(12) Patent Application Publication
(10) Pub. No.: US 2026/0022519 A1
(43) Pub. Date: Jan. 22, 2026

(54) PRODUCING NANOFIBERS, MICROFIBERS, AND LIGNIN FROM LIGNOCELLULOSIC BIOMASS

(71) Applicant: University of Washington, Seattle, WA (US)

(72) Inventors: Danielle Uchimura Pascoli, Seattle, WA (US); Renata Bura, Seattle, WA (US); Anthony B. Dichiara, Seattle, WA (US); Richard R. Gustafson, Seattle, WA (US); Sheila M. Goodman, Seattle, WA (US); Heather G. Niles, Seattle, WA (US); Dylan Edmundson, Seattle, WA (US); Kurt J. Haunreiter, Seattle, WA (US)

(73) Assignee: University of Washington, Seattle, WA (US)

(21) Appl. No.: 18/869,696

(22) PCT Filed: May 26, 2023
(86) PCT No.: PCT/US2023/023779

§ 371 Date: Nov. 26, 2024

Related U.S. Application Data
(60) Provisional application No. 63/347,452, filed on May 31, 2022.

(51) Int. Cl. D21H 11/10; D21H 25/00

(52) U.S. Cl. CPC D21H 11/10; D21H 25/005

(57) ABSTRACT

Various techniques for generating nanocellulose are described. An example method includes generating a first material by performing alkaline peroxide pulping on heterogenous biomass; generating a second material by removing at least a portion of a dissolved lignin fraction from the first material; and generating a third material by performing mechanical fibrillation on the second material. A fourth material is generated by performing an oxidation pretreatment on the third material. A fifth material is generated by performing mechanical fibrillation on the fourth material. The fifth material includes lignocellulosic microfibrils (LCMF) having a dimension in a range of about 10 to about 1,000 nanometers (nm) and/or lignocellulosic nanofibrils (LCNF) having a dimension in a range of about 1 to about 10 nm.

### CROSS-REFERENCE TO RELATED APPLICATION

This application is a U.S. National Phase Application based on International Patent Application No. PCT/US2023/023779, filed on May 26, 2023, which claims the priority of U.S. Provisional Application No. 63/347,452, filed on May 31, 2022, each of which is incorporated by reference herein in its entirety.

### TECHNICAL FIELD

This application relates to techniques for producing materials including lignin and/or cellulose fibers from biomass. In some cases, the materials include nanocellulose.

### BACKGROUND

Cellulose nanofibrils (CNFs, also referred to as “nanocellulose”) have unique properties (e.g., large surface area, biocompatibility, outstanding mechanical properties, low thermal expansion, low density, and biodegradability) that make them a great candidate for application in packaging, construction, cosmetics, biomedical, automotive, papermaking, and more (Dhali, K., et al. (2021), Science of the Total Environment, 775, Article 145871). CNFs are a biomaterial that can be used in polymer composites to reduce the amount of fossil-based plastics used in packaging, thereby reducing the environmental issues associated with plastics production and disposal. CNFs can be used as additives in plastic composites to reduce the amount of petroleum-based compounds and improve the composites' properties.

In particular, biodegradable and hydrophilic polymers, such as poly(vinyl alcohol) (PVA), are known to have inferior mechanical properties than their synthetic counterparts, such as polyethylene, therefore benefiting from the incorporation of other various additives to enhance its properties (Ibrahim, M. M., et al. (2010), Carbohydrate Polymers, 79(3), 694-99). CNFs can improve the mechanical performance of PVA nanocomposites due to CNFs high aspect ratio, large surface area, and good interfacial interactions with PVA matrix.

Still, the full potential of CNF utilization in various markets is hindered by its low production capacity and high price. CNFs can be produced by mechanically fibrillating bleached wood pulp (a high-purity, expensive feedstock including virtually pure cellulose) to isolate the nanofibrils (Yu, S. et al., Environ. Sci. Ecotechnol. 2021, 5, 100077). Pulp feedstock represents one of the major operating costs of nanocellulose production processes. In addition, nanocellulose produced from bleached pulp presents limited properties since it includes a single biopolymer, cellulose.

Due to the high energy demand of mechanical fibrillation, pretreatment techniques can be utilized to facilitate the fibrillation step and reduce energy requirements. 2,2,6,6-Tetramethylpiperidin-1-oxyl (TEMPO) oxidation is an example pretreatment technique. It promotes the oxidation of cellulose fibers, increasing their surface charge density, which results in electrostatic repulsion between the fibers and high nanofibrillation yields (Saito, T., et al. (2007) Biomacromolecules, 8(8), 2485-91). However, the chemicals used to perform TEMPO oxidation are relatively expensive and toxic. Further, TEMPO oxidation is generally used in conjunction with expensive separation processes such as dialysis to remove trace amounts of residual TEMPO from fibers, making scale-up very challenging.

Other processes to produce CNF have been reported in the literature (Liu, K., et al. (2021), Green Chemistry, 23(24), 9723-46; Solala, I., et al. (2020), Cellulose, 27 (4), 1853-77). Among those, a relevant method includes CNF production from Norway spruce fibers via SO₂-ethanol-water pulping, which is based on the AVAP® process employed by American Process Inc. (Rojo, E., et al. (2015), Green Chemistry, 17(3), 1853-66). Still, the costs associated with this process can be high as it utilizes expensive woody biomass feedstock and more severe process conditions (elevated temperature and pressure).

### BRIEF DESCRIPTION OF THE DRAWINGS

Some of the drawings submitted herewith may be better understood in color. Applicant considers the color versions of the drawings as part of the original submission and reserves the right to present color images of the drawings in later proceedings.

FIG. 1 illustrates an example environment for producing nanocellulose materials.

FIG. 2 illustrates examples of a nanofibril and a microfibril, which may be produced using techniques described herein.

FIG. 3 illustrates a system for generating a biopolymer.

FIG. 4 illustrates an example process for generating a lignocellulosic material.

FIG. 5 illustrates an example process for generating a biopolymer.

FIG. 6 illustrates an example process developed to convert wheat straw to lignocellulosic nano and microfibrils via peracetic acid pretreatment.

FIG. 7 illustrates optical transmittances at 660 nm of various compositions.

FIG. 8A illustrates example Fourier transform infrared (FTIR) spectra showing specific chemical bonds of lignocellulosic fibrils and their respective charge density values.

FIG. 8B illustrates example conductometric titration curves of different samples.

FIG. 8C illustrates X-ray diffraction spectra and corresponding CI of different samples.

FIG. 9 illustrates example microscope images and size distribution of different lignocellulosic fibrils.

FIGS. 10A and 10B illustrate example stability comparisons of different prepared lignocellulosic fibrils.

FIGS. 11A to 11D illustrate examples of polyvinyl alcohol (PVA) composite films.

FIGS. 12A to 12F illustrates representative images of fractured surfaces at low and high magnifications of various materials.

FIG. 13 illustrates a summary of process steps to produce lignocellulosic nanofibers from different biomass feedstocks.

FIGS. 14A and 14B illustrate recovery percentages of (FIG. 14A) holocellulose and (FIG. 14B) lignin components after pulping and mild oxidation pretreatment related to untreated biomass.

FIG. 15 illustrates examples of optical transmittance spectra of different lignocellulosic nanofibers suspensions.

FIGS. 16A to 16C illustrate FTIR spectra of LCNFs (FIG. 16A), LCMFs (FIG. 16B), and pulps (FIG. 16C) generated from different biomass feedstocks.

FIG. 17 illustrates examples of images and size distribution curves of nanofibrils prepared from different biomass feedstocks.

FIG. 18 illustrates examples of images and size distribution curves of microfibrils from different biomass feedstocks.

### DETAILED DESCRIPTION

To achieve economic success on a large-scale, CNF production requires a more cost-effective conversion technology (Pascoli et al., Carbohydrate Polymers (2022)). The production of lignocellulosic nanofibrils (also referred to as “lignocellulosic nanofibers” or “LCNF”) is a promising solution to this issue. It utilizes cheaper, lignin-containing feedstocks instead of the fully bleached pulp, along with mild treatments, resulting in high-yield products containing cellulose, hemicellulose, and lignin components (Solala, I., et al. (2020), Cellulose, 27 (4), 1853-77). Hemicellulose and lignin can provide unique properties to LCNF materials. Hemicelluloses are branched, low molecular weight heteropolysaccharides whose specific chemical composition varies with different plant species. Hemicelluloses commonly confer colloidal stability, easier fibrillation, and negative charge to nanofibers (Solala, I. et al., Cellulose 2020, 27, 1853-77; Chaker, A. et al., Cellulose 2013, 20, 2863-75; Iwamoto, S. et al., Biomacromolecules 2008, 9, 1022-26). Lignin is an amorphous polymer that can present different structures depending on the feedstock and process used. It has been reported that lignin provides hydrophobicity, improved barrier properties, antimicrobial activity, and more to the nanofibers (Solala, I. et al., Cellulose 2020, 27, 1853-77; Rojo, E. et al., Green Chem. 2015, 17, 1853-66; Delgado-Aguilar, M. et al., Ind. Crops Prod. 2016, 86, 295-300).

Various implementations described herein relate to techniques for producing products including lignin, lignocellulosic microfibrils (also referred to as “lignocellulosic microfibers” or “LCMF”), LCNF, or any combination thereof, using readily available biomass, such as waste feedstocks. In some cases, the products include bioplastics that include lignin, LCMF, LCNF, or any combination thereof.

Examples of biomass that can be used to generate the products include wheat straw, sugar cane bagasse, rice straw, rice husk, corn stover, hemp, reed canary grass, switchgrass, poplar, spruce, waste and/or recycled paper, or any combination thereof. The use of waste feedstocks that are chemically heterogeneous offers considerable economic and sustainability benefits to traditional techniques for nanocellulose production because they are much cheaper than conventional pulp (Yu, S. et al., Environ. Sci. Ecotechnol. 2021, 5, 100077; Pennells, J. et al., Cellulose 2020, 27, 575-93), they do not require purpose-grown feedstock, and they can produce unique biomaterials with intrinsic properties inherited from the original biomass feedstock that can be modified for a targeted end use.

Various techniques described herein produce the products using a mild process with minimal energy usage and/or without the use of caustic chemicals. Peracetic acid (PAA) pretreatment can be used an alternative to TEMPO oxidation. Unlike the chemicals utilized in TEMPO oxidation, PAA is biodegradable and reacts with lignocellulosic biomass at temperatures lower than 100° C. PAA has strong oxidation potential and selectively removes lignin while simultaneously protecting carbohydrates from solubilizing, promoting higher yields. In addition, PAA may oxidize the reducing ends of carbohydrates, creating a negative surface charge that can help nanofibrillation and promote stable colloidal suspensions (Jaaskelainen, A. S., (2000), Journal of Wood Chemistry and Technology, 20(1), 43-59; Kumar, R., et al. (2013), Bioresource Technology, 372-81; Sharma, N., et al. (2020), Journal of Cleaner Production, 256, Article 120338).

PAA pretreatment offers many advantages compared to the conventional TEMPO oxidation method for CNF production. PAA is less toxic and more environmentally friendly than TEMPO reagents (e.g., NaClO) and provides better control over removing lignin and hemicellulose from the pulp material. In addition, TEMPO oxidation is an extensive reaction carried out using strong delignifying agents that produces materials with very low lignin content and high hemicellulose losses. Thus, implementations of the present disclosure present higher process yields than TEMPO oxidation-based methods by keeping more of the different native components from the original material. Various implementations of the present disclosure utilize mild PAA pretreatment, which retains hemicellulose and residual lignin in the final LCNFs for improved yields.

In addition, PAA and TEMPO have different oxidation mechanisms; PAA oxidizes the reducing ends of carbohydrates, while TEMPO oxidizes the C6 hydroxyl groups of cellulose that are present in a higher number. Hence, the final surface charge of the fibrils produced via PAA and TEMPO will differ significantly.

Various implementations of the present disclosure will now be described with respect to the accompanying figures.

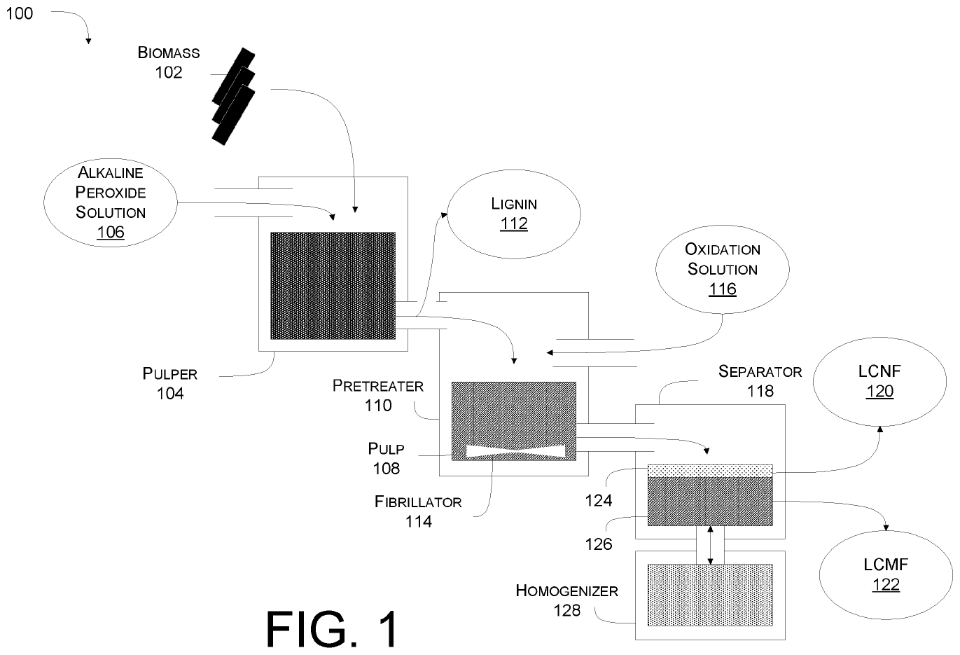

FIG. 1 illustrates an example environment 100 for producing nanocellulose materials. These materials can be generated using biomass 102 as a feedstock. Various types of plant-based materials can be used as the biomass 102. For example, the biomass 102 includes wheat straw, sugar cane bagasse, rice straw, rice husk, corn stover, hemp, reed canary grass, switchgrass, poplar, or spruce. In some examples, the biomass 102 is divided into pieces having a dimension in a range of 10 centimeters (cm) to 1 cm. For example, the biomass 102 can be chopped prior to processing.

In some instances, the biomass 102 includes heterogenous biomass. As used herein, the term “heterogenous biomass,” and its equivalents, refers to a material that includes multiple materials, such as cellulose and at least one non-cellulose material. Heterogenous biomass may be distinct from high-purity biomass sources, such as bleached wood pulp. In some implementations, the biomass 102 includes one or more of hemicellulose, lignin, ash, or an organic extractive. In various cases, the biomass 102 includes multiple parts of a plant, such as any combination of leaves, stalk, trunk, bark, flower, and roots. In some examples, the biomass 102 includes inorganic impurities, such as silica. Thus, various implementations of the present disclosure can be utilized without high-purity biomass sources. In some cases, the biomass 102 includes a waste feedstock from another industrial process.

In various cases, a pulper 104 is configured to pulp the biomass 102 in an alkaline peroxide solution 106. The pulper 104, for example, includes a vessel configured to hold a mixture of the biomass 102 and the solution including the alkaline peroxide 106 during a pulping process. In some cases, the pulper 104 includes at least one inlet configured to convey the biomass 102 and/or alkaline peroxide solution 106 into the interior space of the pulper 104. In some cases, additional water is added to the interior space of the pulper 104. The pulper 104 may be configured to mechanically agitate the mixture of the biomass 102 and the alkaline peroxide solution 106. The pulper 104 in various cases, can be a drum pulper, a hydrapulper, a broke pulper, or a combination thereof.

The alkaline peroxide solution 106, in various cases, is configured to chemically react with the biomass 102. In particular cases, the alkaline peroxide solution 106 fractionates lignin from other chemical structures in the biomass 102. The alkaline peroxide solution 106 may include water. In various examples, the alkaline peroxide solution 106 includes a hydroxide, such as sodium hydroxide, potassium hydroxide, ammonium hydroxide, or a combination thereof. For example, the alkaline peroxide solution 106 includes the hydroxide in a weight percentage (weight %) that is in a range of 10 to 20. In various cases, the alkaline peroxide solution 106 includes a peroxide, such as hydrogen peroxide. For instance, the alkaline peroxide solution 106 includes the peroxide in a range of 5 weight % to 10 weight %. According to some examples, the alkaline peroxide solution 106 includes a chelating agent, such as an acetic acid. Examples of the chelating agent include diethylenetriamine pentaacetate (DTPA) and ethylenediaminetetraacetic acid (EDTA). For instance, the alkaline peroxide solution 106 includes the chelating agent at a weight % that is in a range of 0.10 to 0.20.

The mixture of the biomass 102 and the alkaline peroxide solution 106 may be processed by the pulper 104 at a particular consistency. For example, the mixture in the pulper 104 may have a liquid-to-biomass (mass) ratio that is between 4:1 and 15:1. In some examples, the pulper 104 includes a heater configured to maintain a particular temperature within the interior space of the pulper 104 as the biomass 102 and the alkaline peroxide solution 106 are being agitated. For example, the heater may maintain the temperature of the mixture in a range of 60 degrees C. (° C.) and 100° C. The pulper 104 may process the mixture during a time interval in a range of 30 minutes to 3 hours. In some implementations, the mixture is quenched.

The pulper 104 transforms the biomass 102 into a pulp 108. In some cases, the pulp 108 is washed. For example, the alkaline peroxide solution 106 is rinsed from the pulp 108 with water, and the pulp 108 is transported into a pretreater 110 for further processing. In some implementations, the pulper 104 includes one or more outlet configured to output the pulp 108 into the pretreater 110.

Additionally, in some implementations, lignin 112 is separated from the pulp 108. For example, a slurry including the lignin 112 is filtered from the mixture and/or the pulp 108. Various types of filters can be used to remove the dissolved lignin 112, such as paper filters, screens, or screw press filters. In some examples, the slurry is mixed with an acid, such as sulfuric acid, hydrochloric acid, or acetic acid. In some cases, the slurry is dewatered and dried, such that the lignin 112 can be recovered as a precipitate. In some implementations, the lignin 112 is incorporated into an additional material, such as a tire, or other polymer composition. In some cases, the lignin 112 is incorporated into a fire retardant material, a road dust preventer, a chelating agent, an emulsifier, a binding agent, or an adhesive.

According to some implementations, the pretreater 110 includes a fibrillator 114 configured to mechanically fibrillate the pulp 108 output by the pulper 104. The pulp 108, for instance, is mixed with water or another type of aqueous solution prior to fibrillation. In some cases, the fibrillator 114 includes a blender. As used herein, the term “blender,” and its equivalents, may refer to a device that includes one or more rotating blades configured to chop, puree, liquify, or otherwise mix a material. In some implementations, the fibrillatory 114 includes a sonicator. As used herein, the term “sonicator,” and its equivalents, may refer to a device including one or more ultrasound transducers configured to generate ultrasound that mixes, heats, or otherwise processes a material. For example, the ultrasound may induce cavitation in the material in order to fibrillate the material. In some implementations, the fibrillator 114 is a pulper, such as a hydrapulper. In various implementations, the fibrillator 114 fibrillates a mixture of the pulp 108 and water, wherein the mixture has a consistency between 1% and 15%. In some implementations, the mixture is further refined (e.g., to a consistency between 5% and 15%) and/or filtered.

In various cases, the pretreater 110 processes the pulp 108 using an oxidation solution 116. In some cases, the oxidation solution 116 is added after the pulp 108 is fibrillated by the fibrillator 114. For example, the pretreater 110 includes one or more inlets configured to transport the pulp 108 and/or the oxidation solution 116 into an interior space of the pretreater 110. For instance, the pretreater 110 includes a vessel configured to hold a mixture of the pulp 108 and the PAA solution 114.

The oxidation solution 116, in various cases, is an aqueous solution including a peroxide. In some cases, the peroxide includes hydrogen peroxide and/or peracetic acid (PAA). Other oxidation agents can be used, such as performic acid, ozone, potassium permanganate, and chlorine dioxide. In some cases, the oxidation solution 116 includes 1 to 5 weight % of the peroxide or other oxidation agent. For example, the oxidation solution 116 has a pH between 4 and 5.5.

In some implementations, the pretreater 110 is configured to mix the pulp 108 and the oxidation solution 116. The mixture, for instance, has a consistency in a range of 1% to 10%. According to some examples, the pretreater 110 includes a heater configured to maintain the mixture of the pulp 108 and the oxidation solution 116 at a temperature that is below the boiling point of water. For instance, the temperature is in a range of 60° C. and 100° C. In various implementations, the temperature is maintained for a time period in a range of 15 minutes to 2 hours. According to some examples, the pretreater 110 is further configured to quench the mixture. In some implementations, the pretreater 110 is further configured to wash the pulp 108 with water or a caustic solution. In some implementations, the caustic solution includes an aqueous solution of sodium hydroxide, ammonium hydroxide, potassium hydroxide, or a combination thereof.

In various cases, the pretreater 110 performs multiple pretreatments on the pulp 108. For example, the pretreater 110 may quench and/or rinse the pulp 108 after it has been treated with the oxidation solution 116, and may further receive another oxidation solution to perform an additional treatment on the pulp 108. In some cases, the second pretreatment is similar or identical to the first pretreatment process. In some cases, the second oxidation solution has a greater weight percentage of a peroxide (e.g., PAA) than the oxidation solution 116. For instance, the second peroxide solution may have PAA in a range of 1 to 5 weight % and/or a pH in a range of 4 to 5.5. According to various implementations, the second pretreatment includes mixing the pulp 108 and the second oxidation solution at a consistency in a range of 0.5 to 2%.

The pulp 108, after being subjected to one or more PAA pretreatment processes, may be output from the pretreater 110. For example, the pretreater 110 includes one or more outlets configured to output the pretreated pulp 108. In various implementations, the pretreated pulp 108 is output into a separator 118.

The separator 118 is configured to separate lignocellulosic nanofibrils (LCNF) and lignocellulosic microfibrils (LCMF) from the pretreated pulp 108, in some cases. As used herein, the term “LCNF,” and its equivalents, may refer to a material having at least one dimension in that is in a range of 1 to 10 nanometers (nm). As used herein, the term “LCMF,” and its equivalents, may refer to a material having at least one dimension that is in a range of 10 to 1,000 nm. As used herein, the term “nanocellulose,” and its equivalents, may refer to LCNF, LCMF, or any combination thereof. In some examples, the separator 118 includes a centrifuge. For example, the separator 118 may centrifuge the pretreated pulp 108. By centrifuging the pretreated pulp 108, a supernatant 124 and a precipitate 126 may be generated. The supernatant 124, for instance, includes the LCNF 120.

In some cases, the precipitate 126 is input into a homogenizer 128 for further processing. For example, the homogenizer 128 includes a microfluidizer, a sonicator, a high-pressure homogenizer, or another type of mechanical fibrillator. The homogenizer 128 is configured to homogenize the pretreated pulp 108 and/or the precipitate 126. A homogenized material output by the homogenizer 128 may be input back into the separator 118. In various implementations, the separator 118 may isolate further LCNF 120 from the homogenized material as an additional supernatant. In various cases, the separator 118 may further isolate the LCMF 122 from the homogenized material as an additional precipitate.

Various compositions may be generated using the LCNF 120 and/or LCMF 122. In some implementations, nanocellulose including the LCNF 120 and/or LCMF 122 may include cellulose, hemicellulose, lignin, or a combination thereof. For example, the nanocellulose may include cellulose in a range of 60 to 98 weight %; hemicellulose in a range of 1 to 25 weight %; lignin in a range of 1 to 15 weight %, or any combination thereof. In some implementations, a biopolymer is generated using the nanocellulose. For example, the nanocellulose may be cast with polyvinyl alcohol (PVA) to generate a biopolymer composition.

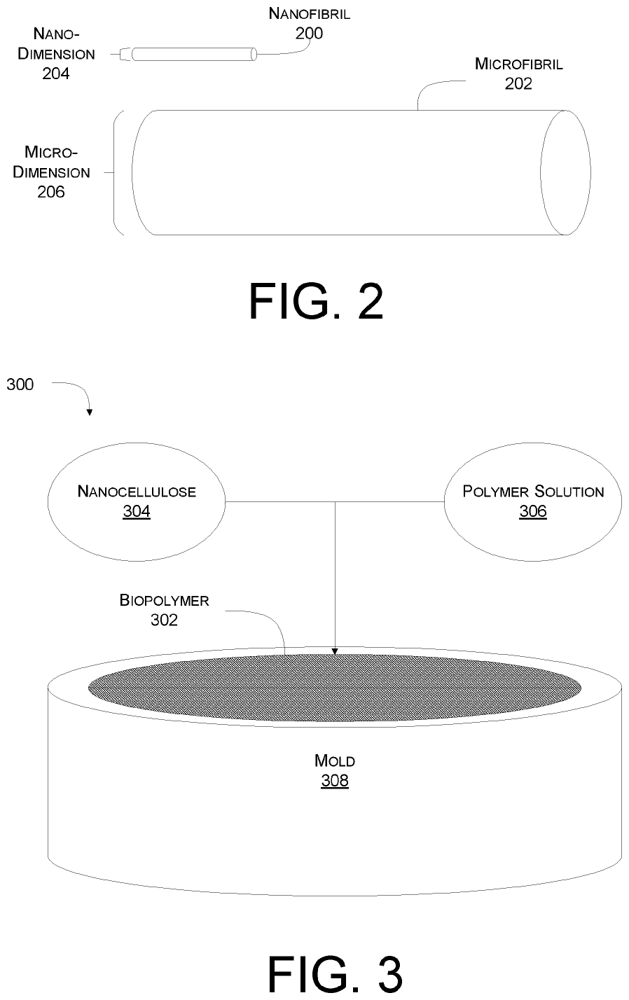

FIG. 2 illustrates examples of a nanofibril 200 and a microfibril 202, which may be produced using techniques described herein. The nanofibril 200 has at least one nano-dimension 204. The nano-dimension 204 has a length in a range of 1 nanometer (nm) to 10 nm. The microfibril 202 has at least one micro-dimension 206. For example, the micro-dimension 206 has a length in a range of 10 nm to 1,000 nm.

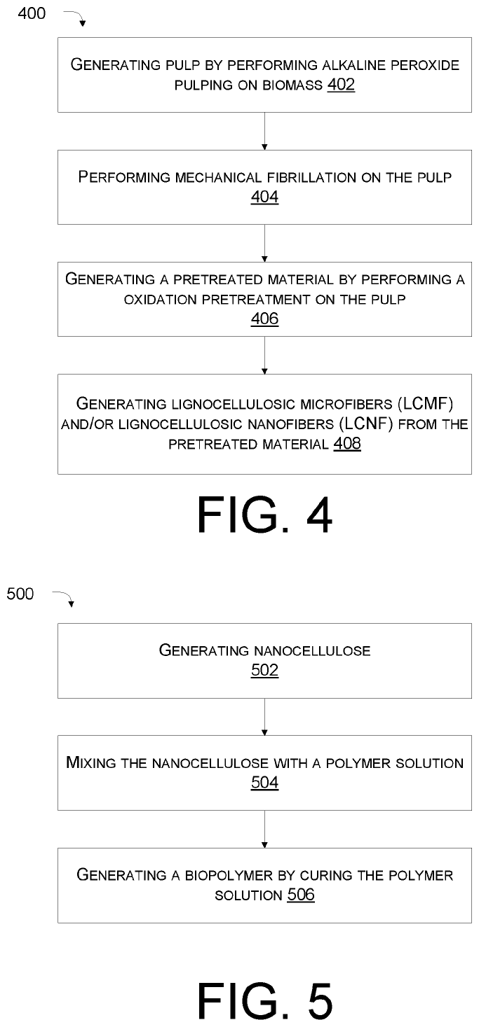

FIG. 3 illustrates a system 300 for generating a biopolymer 302. In various implementations, the biopolymer 302 is generated by combining a nanocellulose 304 with a polymer solution 306.

The nanocellulose 304, in various cases, is generated using various techniques described herein. In various cases, the nanocellulose 304 includes lignin, cellulose, hemicellulose, or a combination thereof. For instance, the nanocellulose 304 includes 60 to 98 weight % cellulose, 1 to 25 weight % hemicellulose, 1 to 15 weight % lignin, or a combination thereof. In some cases, the nanocellulose 304 includes an aqueous solution. According to various implementations, the nanocellulose 304 includes LCNF and/or LCMF.

The polymer solution 306, in various cases, includes monomers that are configured to polymerize. For example, the polymer solution 305 includes a polyvinyl alcohol (PVA) solution.

A mixture of the nanocellulose 304 and the polymer solution 306 is placed in a mold 308 for curing. In some cases, the curing occurs as a solvent in the polymer solution 306 evaporates. In some examples, the curing occurs when the mixture is heated or exposed to ultraviolet (UV) radiation. The biopolymer 302 is generated when the mixture of the lignocellulosic material and the polymer solution 306 is cured in the mold 308. In various cases, the biopolymer 302 includes 1 to 10 weight % of the nanocellulose 304 and 99 to 90 weight % of the polymer.

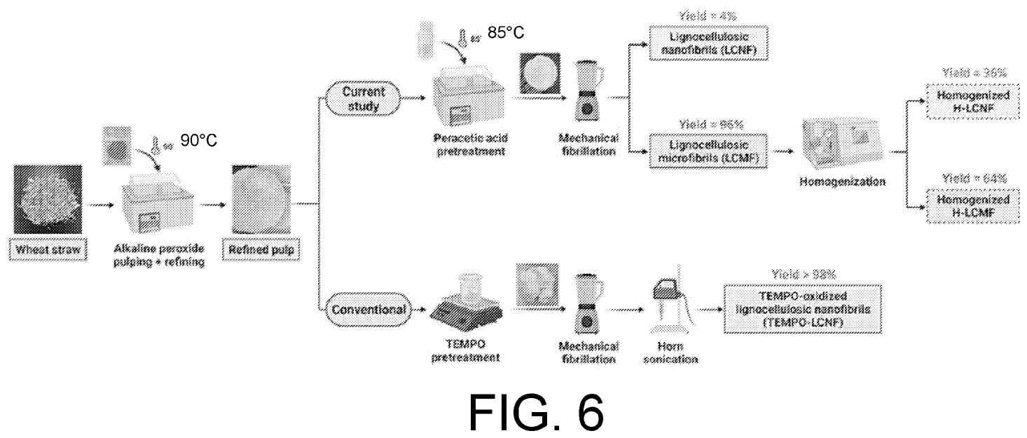

FIG. 4 illustrates an example process 400 for generating a lignocellulosic material. The process 400 may be performed by an entity, such as a system, one or more vessels, one or more pumps, a pulper, a pretreater, a fibrillator, a separator, a homogenizer, or any combination thereof.

At 402, the entity generates a pulp by performing alkaline peroxide pulping on biomass. The biomass, in various implementations, is heterogenous biomass. In various cases, the biomass includes cellulose and at least one non-cellulose material. For example, the biomass includes hemicellulose, lignin, ash, an organic extractive, or any combination thereof. In some examples, the biomass includes leaves and/or stalks of a plant. In some cases, the biomass includes at least one of wheat straw, sugar cane bagasse, rice straw, rice husk, corn stover, hemp, reed canary grass, switchgrass, poplar, spruce, or any combination thereof. The biomass, in some examples, includes residues of an agricultural process.

In various implementations, the biomass is pulped in the presence of an alkaline peroxide solution. The alkaline peroxide solution may be an aqueous solution. The alkaline peroxide solution, in various implementations, includes one or more peroxides, such as hydrogen peroxide, sodium peroxide, potassium peroxide, or any combination thereof. The alkaline peroxide solution, for example, includes the peroxide(s) in a range of 5 to 10 weight %. In various cases, the alkaline peroxide solution further includes one or more hydroxides, such as sodium hydroxide, potassium hydroxide, ammonium hydroxide, or any combination thereof. The alkaline peroxide solution, for instance, includes the hydroxide(s) in a range of 10 to 20 weight %. In some examples, the alkaline peroxide solution includes a chelating agent, such as DTPA and/or EDTA. The alkaline peroxide solution, in some cases, includes the chelating agent in a range of 0.10 to 0.20 weight %.

According to some examples, the biomass is mixed with the alkaline peroxide solution at a liquid-to-biomass (mass) ratio in a range of 4:1 to 15:1. In some examples, the mixture is heated at a temperature that is below the boiling point of water. For example, the mixture is pulped at a temperature in a range of 60 to 100 degrees C. The pulp, in various cases, is further quenched and/or rinsed (e.g., with water). In various cases, a dissolved lignin fraction is removed from the pulp.

At 404, the entity performs mechanical fibrillation on the pulp. The pulp, for example, is fibrillated with water. In some cases, the pulp and the water are fibrillated at a consistency in a range of 1 to 15%. In various implementations, the fibrillation is performed by at least one of a blender, a hydrapulper, or a mechanical refiner.

At 406, the entity generates a pretreated material by performing an oxidation pretreatment on the pulp. In various implementations, pulp is pretreated in the presence of an oxidation solution, such as a peroxide solution. The oxidation solution may include one or more peroxides, such as PAA and/or hydrogen peroxide. For instance, the oxidation solution includes the peroxide(s) in a range of 1 to 5 weight %. The oxidation solution may be acidic. For example, the oxidation solution may have a pH in a range of 4 to 5.5. The mixture of the pulp and the oxidation solution may have a consistence in a range of 1 to 10%. In some examples, a mixture of the pulp and the oxidation solution is heated to a temperature that is below the boiling point of water. For example, the mixture is heated to a temperature in a range of 60 to 100 degrees C. In some cases, the mixture is washed with water and/or a caustic solution. For example, the caustic solution includes an aqueous solution of sodium hydroxide, ammonium hydroxide, potassium hydroxide, or a combination thereof.

Optionally, multiple oxidation pretreatments are performed on the pulp. For instance, the pretreated pulp may be further mixed with an additional oxidation solution. In some implementations, the additional oxidation solution includes a higher concentration of solutes (e.g., PAA) than the original oxidation solution.

At 406, the entity generates nanocellulose from the pretreated material. The nanocellulose, for example, includes LCMF, LCNF, or a combination thereof. According to some examples, the pretreated material is mechanically fibrillated (e.g., at a consistency in a range of 0.2 to 1.0 weight %). In some cases, the pretreated material is homogenized. For example, microfluidzation, high pressure-homogenization, sonification, or a combination thereof, is performed. In some examples, the LCNF and/or LCMF are separated from each other by centrifugation.

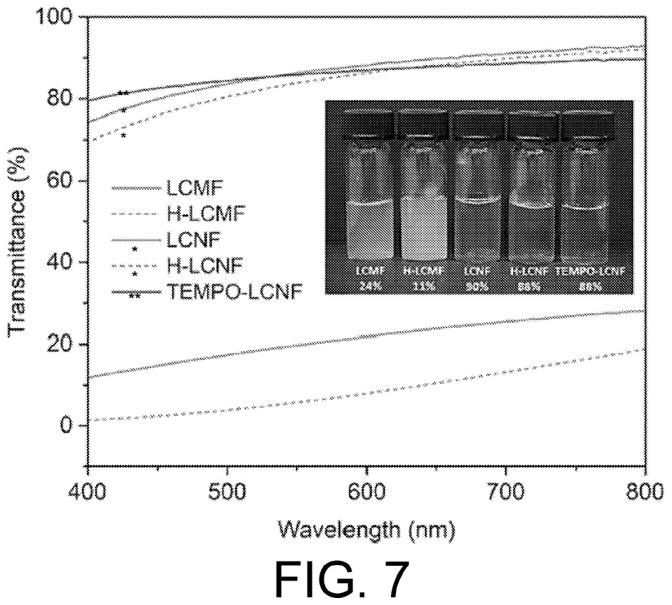

FIG. 5 illustrates an example process 500 for generating a biopolymer. The process 500 may be performed by an entity, such as a system, one or more vessels, one or more pumps, a mold, or any combination thereof.

At 502, the entity generates nanocellulose. For example, the entity performs alkaline peroxide pulping on biomass. In some cases, the biomass includes heterogenous biomass. The resultant pump may be fibrillated an subjected to an oxidation pretreatment. For example, a PAA pretreatment is performed. In various cases, the resultant pretreated material is fibrillated and/or homogenized. The nanocellulose, which may include LCNF and/or LCMF, can therefore be obtained. The nanocellulose, in various implementations, includes cellulose, hemicellulose, and lignin.

At 504, the entity mixes the lignocellulosic material with a polymer solution. In various cases, the polymer solution includes monomers that are configured to polymerize together. In some cases, the polymer solution includes a polymer, such as polyvinyl acetate, a vinyl ester-derived polymer with a group that is an alternative to acetate (e.g., a formate or chloroacetate group), or a combination thereof.

At 506, the entity generates a biopolymer by curing the polymer solution. For example, the polyvinyl esters in the mixture are converted into PVA by reacting with ethanol. In various cases, the biopolymer includes the nanocellulose in a range of 1 to 10 weight %. In various implementations, the biopolymer includes the polymer (e.g., PVA) in a range of 99 to 90 weight %.

Particular implementations will now be described with reference to multiple Experimental Examples. The descriptions of the Experimental Examples are included to illustrate some, but not all, implementations of the present disclosure. Accordingly, the scope of the disclosure or the accompany claims should not be interpreted to be limited to the particular techniques described with reference to the Experimental Examples.

### First Experimental Example

Cellulose nanofibrils are typically prepared from high-purity bleached pulp through harsh chemical treatments (e.g., TEMPO oxidation), resulting in high costs and environmental impact. In this Example, inexpensive wheat straw feedstock and alkaline peroxide pulping followed by mild PAA pretreatment was used to produce lignocellulosic nanomaterials (nano and microfibrils) with bioplastics applications. PAA was chosen due to its biodegradability, non-toxicity, and high reaction selectivity. As-synthesized lignocellulosic nanomaterials were thoroughly characterized and compared to nanofibrils produced via TEMPO oxidation pretreatment and then applied as reinforcing agents in plastic composites. A remarkable case of simultaneous strengthening and toughening of the polymer nanocomposite was achieved with high specific tensile strength (up to 59.5 MPa g⁻¹cm³), elastic modulus (up to 2.6 GPa g⁻¹cm³), and fracture strain (up to 138%). This Example is a comprehensive investigation of all process steps involved in lignocellulosic nanomaterials production, from original residue feedstock to final product application.

This Example provides techniques for producing nanomaterials with effective plastic reinforcing properties by utilizing low-cost agricultural residue feedstock (wheat straw or “WS”) along with mild alkaline peroxide pulping followed by environmentally friendly PAA pretreatment. The proposed process comprising PAA pretreatment results in nanomaterials with different structure and composition than that obtained via TEMPO oxidation, thus the impact of such differences in their application in polymer composites is also investigated.

Therefore, this Example comprehensively investigates steps involved in lignocellulosic nanomaterials production, from original residue feedstock to final product application. First, by using biomass raw material and mild process conditions, hemicellulose and lignin components were preserved along with cellulose, resulting in lignocellulosic nanomaterials (LCNF and LCMF) with high yields. The changes in the chemical composition of the WS fibers after each chemical reaction were also assessed. Then, the lignocellulosic nanomaterials produced via PAA pretreatment were thoroughly characterized (light transmittance, surface charge density, crystallinity, FTIR, fiber morphology, thermal stability) and compared to nanofibrils obtained via TEMPO oxidation. Finally, all fibrils produced were added to PVA plastic nanocomposites as reinforcing agents, and the final properties of the composites were correlated with the chemical and morphological characteristics of the fibrils.

### Procedures

WS bales were sourced from Snohomish County, WA. Sample preparation consisted of cutting the whole wheat straw into half-inch pieces using a hand pruner. The feedstock was air-dried (moisture content 6.7%) and stored in closed containers at ambient temperature until use. Mild delignification of wheat straw was done by alkaline peroxide pulping at 90° C. for 150 min. After the pulping reaction, the sample was vacuum filtered, and the pulp was extensively washed with deionized (DI) water. Finally, the washed pulp was refined using a laboratory PFI mill, resulting in WS refined pulp.

WS refined pulp was treated with PAA. The refined pulp was mixed with a PAA solution at pH 4.8 in a plastic bottle, and the reaction was carried out at 85° C. for 45 min. Then, pretreated pulp underwent step wash with a caustic solution followed by DI water.

The PAA pretreated pulp was mechanically fibrillated using a blender and centrifuged, resulting in two product fractions that fall under the standard definition of “nanocellulose” or “cellulose nanomaterial” (fibrils composed predominantly of cellulose with any dimension in the nanoscale from 1 to 100 nm). The supernatant fraction contained individual elementary fibrils up to 5 nm wide—denominated as LCNF, while the precipitate contained fibrils 10-100 nm (denominated as LCMF). LCMF was further subjected to homogenization using a high-pressure microfluidizer and subsequently centrifuged to separate the homogenized H-LCNF (supernatant) and H-LCMF (precipitate). LCNF and H-LCNF suspensions were concentrated by vacuum-rotary drum evaporation at 90° C. Samples were stored in glass bottles at room temperature until use.

For comparison purposes, TEMPO-oxidized LCNFs (TEMPO-LCNF) were prepared from WS refined pulp based on a previously reported procedure (Gu, J., et al. (2018), Applied Catalysis B: Environmental, 237, 482-90). In addition, a pretreatment control (PC) was also prepared by fibrillating the WS refined pulp (without pretreatment) with a blender, followed by centrifuging.

After pulping and pretreatment (PAA or TEMPO), the total mass yield was determined gravimetrically by comparing the oven-dry (OD) weight of fibers obtained at each process with that of the starting original WS.

To evaluate the effects of formed in this study, the chemical composition of original WS, WS refined pulp, PAA pretreated pulp, and TEMPO pretreated pulp were assessed. The carbohydrates and lignin content (including both acid-soluble and acid-insoluble lignin) were quantified according to methods previously described (Dou, C., et al. (2019), Industrial Crops and Products, 132, 407-12; Dou, C., et al. (2017). Biotechnology for Biofuels, 10(1), 15; Horhammer, H., et al. (2018), Biotechnology for Biofuels, 11; Pascoli, et al., Biotechnol. Biofuels 14, 9 (2021)). Ash content was measured gravimetrically, and total extractives content was determined by water and ethanol Soxhlet extraction with a 12 h reflux time (Sluiter, A., et al. (2008), Determination of extractives in biomass: Laboratory analytical procedure (LAP); Sluiter, A., et al. (2008), Determination of ash in biomass: Laboratory analytical procedure (LAP)).

The product separation yield was determined by centrifugation. Samples underwent a centrifugation step to separate the final products. For TEMPO pretreatment, only one fraction of product was obtained (TEMPO-LCNF), whereas, for the process proposed in this study, two fractions of products (precipitate/supernatant) were obtained after centrifugation (LCMF/LCNF and H-LCMF/H-LCNF). The product separation yields, expressed as percentages, were calculated by the OD weight ratio of each product fraction to the pre-centrifugation suspension.

Light transmittance of lignocellulosic fibrils (nano and micro) suspensions was conducted using UV/VIS/NIR Spectrophotometer with scans ranging from 400 to 800 nm. Fiber morphology was characterized by optical microscopy, scanning electron microscopy (SEM), and atomic force microscopy (AFM) techniques. Charge density was determined by conductometric titration. Crystallinity index was determined by X-ray diffraction (XRD). Fourier transform infrared spectroscopy (FTIR) was used to evaluate bonds within samples, and thermal stability was evaluated by Thermogravimetric analysis (TGA).

PVA composite films were prepared via a casting method as previously reported (Lu, J., et al. (2008), Composites Part A: Applied Science and Manufacturing, 39(5), 738-46) with minor modifications. PVA composite films were reinforced with 5 wt % of lignocellulosic fibrils (LCMF, H-LCMF, LCNF, H-LCNF, and TEMPO-LCNF) unless otherwise specified, and a neat PVA sample was prepared as a control. Because the H-LCNF sample showed different reinforcing trends than all other samples (as shown in Results and Discussion), PVA composites with different H-LCNF contents (2.5, 5.0, and 7.5 wt %) were further prepared. As-prepared nanocomposite films were conditioned for 48 h at 25° C. and 50% relative humidity prior to further testing. Optical transmittance spectra of PVA composite films were determined by UV/VIS/NIR Spectrophotometer with scans ranging from 400 to 800 nm. The light transmittance of different samples was evaluated using the percent transmittance at 660 nm (Espinosa, E., et al. (2017), Cellulose, 24(6), 2605-18). Tensile properties of composite films were determined using a tensile tester (standard method ASTM D638-10) with a gauge length of 50 mm (Espinosa, E., et al. (2017), Cellulose, 24(6), 2605-18). A minimum of five test specimens per sample was tested. The fracture surface of PVA composite films was examined using SEM.

### Results and Discussion

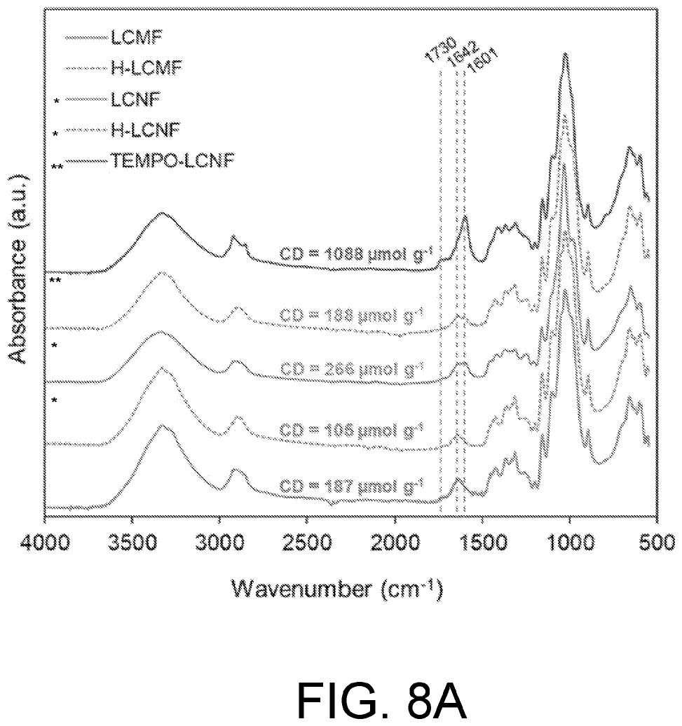

FIG. 6 illustrates an example process developed to convert wheat straw to lignocellulosic nano and microfibrils via peracetic acid pretreatment. Conventional TEMPO oxidation pretreatment was performed as a comparison. As seen in FIG. 6, TEMPO-LCNF had a much higher separation yield than the other samples, resulting in only one product fraction. In contrast, two product fractions were obtained for the PAA process after each separation step. After PAA pretreatment and mechanical fibrillation, the yield of LCMF was much higher than LCNF (96% and 4%, respectively). Then, by introducing the homogenization step, the yield of H-LCNF increased significantly to 36%, revealing that higher defibrillation energy is required to release the nanofibrils. Even though homogenization can be costly, this process change may be economically beneficial as nanofibrils are a higher value product compared to microfibrils.

Changes in chemical composition and mass balance throughout the process, including total mass yield as well as sugar (cellulose and hemicellulose) and lignin recovery related to original WS, are presented in Table 1.

TABLE 1
Chemical composition of original WS, WS refined pulp,
PAA pretreated pulp, and TEMPO pretreated pulp, and
mass balance results related to original WS.

| | Chemical composition (%) ^{a} | | | | |
|---|---|---|---|---|---|
| | Cellu- | Hemicel- | | | |
| | lose | lulose | Lignin | Ash | Extractives |
| Original WS | 35.6 ± | 22.0 ± | 28.1 ± | 11.4 ± | 13.4 ± |
| | 0.1 | 0.0 | 0.4 | 0.1 | 0.0 |
| WS refined pulp | 57.7 ± | 26.6 ± | 8.2 ± | 1.9 ± | 2.7 ± |
| | 0.7 | 0.3 | 0.1 | 0.1 | 0.3 |
| PAA | 67.1 ± | 25.5 ± | 7.0 ± | 0.3 ± | 0.0 ± |
| pretreated pulp | 0.5 | 1.0 | 0.4 | 0.0 | 0.0 |
| TEMPO | 69.4 ± | 19.6 ± | 1.2 ± | 0.0 ± | 0.0 ± |
| pretreated pulp | 0.9 | 1.3 | 0.0 | 0.0 | 0.0 |

| | Mass balance ^{b} | | | |
|---|---|---|---|---|
| | Mass | Cellulose | Hemicellulose | Lignin |
| | yield % | recovery % | recovery % | recovery % |
| Original WS | — | — | — | — |
| WS refined pulp | 65.8 | 99.9 | 79.6 | 19.2 |
| PAA | 52.9 | 99.7 | 61.3 | 13.2 |
| pretreated pulp | | | | |
| TEMPO | 48.0 | 93.5 | 42.8 | 2.1 |
| pretreated pulp | | | | |

^{a} Chemical composition as a percentage of the OD weight of each sample. Average of triplicate measurements.
^{b} Mass balance was calculated by assuming no mass loss during mechanical treatment steps and correlating the chemical composition and mass yield at each stage to the starting original WS.

Various screened conditions are summarized in the following Table 2:

TABLE 2
Summary of process conditions during screening and
the chemical composition of the resulting fibers.
Experimental parameters

| | | Time | Temp | | NaOH | H₂O₂ | H₂SO₄ |
|---|---|---|---|---|---|---|---|
| No | Feedstock | (min) | (° C.) | Solvent | charge | charge | charge |
| 1 | Dry wheat | 60 | 90 | water | 15% | 7.5% | — |
| | straw (clean) | | | | | | |
| 2 | Soaked WS | 60 | 90 | water | 15% | 7.5% | — |
| | (clean) | | | | | | |
| 3 | Dry wheat | 75 | 90 | water | 15% | 7.5% | — |
| | straw (clean) | | | | | | |
| 4 | Soaked WS | 75 | 90 | water | 15% | 7.5% | — |
| | (clean) | | | | | | |
| 5 | Dry wheat | 75 | 90 | 100% | 15% | 7.5% | — |
| | straw (clean) | | | glycerol | | | |
| 6 | Dry wheat | 75 | 90 | 100% | 15% | — | — |
| | straw (clean) | | | glycerol | | | |
| 7 | Dry wheat | 225 | 90 | 100% | 15% | — | — |
| | straw (clean) | | | glycerol | | | |
| 8 | Dry wheat | 75 | 90 | 50% | 15% | — | — |
| | straw (clean) | | | glycerol | | | |
| 9 | Dry wheat | 225 | 90 | 50% | 15% | — | — |
| | straw (clean) | | | glycerol | | | |
| 10 | Dry wheat | 150 | 90 | water | 15% | 7.5% | — |
| | straw (clean) | | | | | | |
| 11 | Dry wheat | 75 | 90 | water | 15% | — | — |
| | straw (clean) | | | | | | |
| 12 | Dry wheat | 75 | 90 | 100% | — | — | 1% |
| | straw (clean) | | | glycerol | | | |
| 13 | Dry wheat | 75 | 90 | 100% | — | — | 5% |
| | straw (clean) | | | glycerol | | | |
| 14 | Dry wheat | 75 | 90 | 50% | — | — | 1% |
| | straw (clean) | | | glycerol | | | |
| 15 | Dry wheat | 75 | 90 | 50% | — | — | 5% |
| | straw (clean) | | | glycerol | | | |
| 16 | Dry wheat | 75 | 90 | water | — | — | 1% |
| | straw (clean) | | | | | | |
| 17 | Dry wheat | 75 | 90 | water | — | — | 5% |
| | straw (clean) | | | | | | |
| 18 | Dry WHOLE | 75 | 90 | water | 15% | 7.5% | — |
| | wheat straw | | | | | | |
| 19 | Dry WHOLE | 150 | 90 | water | 15% | 7.5% | — |
| | wheat straw | | | | | | |
| 20 | Dry wheat | 150 | 90 | water | 15% | — | — |
| | straw (clean) | | | | | | |

Chemical composition

| | Cellulose | Hemicellulose | Lignin | Ash |
|---|---|---|---|---|
| No | content % | content % | content % | content % |
| 1 | 55.9 | 24.4 | 9.6 | 1.8 |
| 2 | 56.6 | 24.4 | 8.4 | 1.7 |
| 3 | 56.8 | 24.8 | 8.8 | 1.5 |
| 4 | 56.6 | 24.5 | 8.7 | 1.6 |
| 5 | 44.4 | 25.0 | 21.4 | 6.7 |
| 6 | 44.5 | 24.7 | 21.2 | 6.8 |
| 7 | 46.9 | 25.4 | 18.0 | 5.6 |
| 8 | 51.7 | 26.9 | 11.3 | 1.9 |
| 9 | 52.5 | 26.7 | 10.7 | 1.8 |
| 10 | 59.1 | 26.0 | 8.4 | 1.2 |
| 11 | 56.2 | 24.8 | 11.5 | 1.3 |
| 12 | 40.7 | 23.7 | 27.1 | 6.8 |
| 13 | 30.4 | 22.2 | 27.3 | 6.6 |
| 14 | 39.3 | 23.0 | 29.7 | 6.9 |
| 15 | 38.9 | 22.1 | 28.6 | 6.3 |
| 16 | 38.8 | 23.9 | 27.1 | 9.5 |
| 17 | 37.7 | 23.2 | 29.7 | 9.7 |
| 18 | 55.2 | 25.1 | 9.1 | 1.9 |
| 19 | 55.8 | 25.7 | 7.9 | 1.9 |
| 20 | 54.9 | 24.5 | 9.8 | 1.8 |

Conditions “19” were selected. The selected alkaline peroxide pulping conditions removed 81% of lignin from the original WS, resulting in pulp with only 8.2% lignin, thus validating the effectiveness of the delignification step. A similar pulping process was explored in prior studies, where a wheat straw delignification of up to 60% was obtained through alkaline peroxide pulping (Yuan, Z., et al. (2018), Bioresource Technology, 259, 228-36). The higher lignin removal obtained in the current study can be attributed to different reaction conditions (temperature, time, and chemical charges). Unlike lignin, virtually all the cellulose (100%) and the majority of hemicellulose (80%) remained in the refined pulp, indicating a low sugar loss during the reaction. Hemicellulose was more susceptible to solubilization during pulping than cellulose because of its lower molecular weight, higher branching, and direct linkages with lignin (i.e., lignin-carbohydrate complexes).

The delignification and partial solubilization of hemicelluloses linked to lignin result from the formation of radicals (hydroxyl and superoxide anion) during the reaction, causing the oxidation of lignin molecules to form alkali-soluble moieties (Fang, J. M., et al. (1999). Polymer Degradation and Stability, 66, 423-32; Sun, J. X., et al. (2004), Journal of Wood Chemistry and Technology, 24(3), 239-62).

In general, conventional delignification methods such as Kraft, soda, and sulfite pulping require high temperatures (above 100° C.) and high pressure, significantly increasing the production costs (Bian et al. (2019), Polymers, 11(2)). Besides the cost factor, the harsh conditions utilized by these pulping methods also promote the solubilization of hemicellulose, resulting in lower yields. For instance, different pulping methods (soda, organosolv, and kraft) have resulted in WS pulp yields between 40 and 50% (Sanchez, R., et al. (2016), International Journal of Biological Macromolecules, 92, 1025-33). The mild alkaline peroxide pulping process used in the present study resulted in a substantial WS pulp yield of 66% by keeping most of the hemicellulose and part of the lignin in the fibers. The higher mass yield is good for the process' viability, as more of the original biomass feedstock is kept in the final product, and less is wasted.

After the delignification step, two different pretreatments (PAA and TEMPO oxidation) were separately performed and compared (FIG. 6). The PAA pretreatment resulted in higher mass yield (related to original WS biomass) than TEMPO pretreatment (53% and 48%, respectively) because of its higher cellulose, hemicellulose, and lignin recovery (Table 1). These results are attributed to the mild PAA delignification in contrast to the more aggressive TEMPO oxidation. The NaClO employed during TEMPO oxidation is a strong delignifying agent, resulting in TEMPO pretreated pulp with only 1% lignin content. Previous studies performing PAA treatments have reported higher delignification values (achieving pulps with <1% lignin), which can be associated with the longer reaction times (up to 240 min) and higher temperatures (95-97° C.) employed (Barbash, V. A. et al. (2022), Applied Nanoscience, 12(4), 835-48; Barbash, V. A., et al. (2020), SN Applied Sciences, 2(4), 1-12). Furthermore, PAA is a biodegradable, non-toxic chemical that is more economical and environmentally friendly than TEMPO reagents. Therefore, PAA pretreatment is advantageous to be implemented at an industrial scale compared to TEMPO oxidation due to its that, unlike not require a subsequent expensive dialysis step.

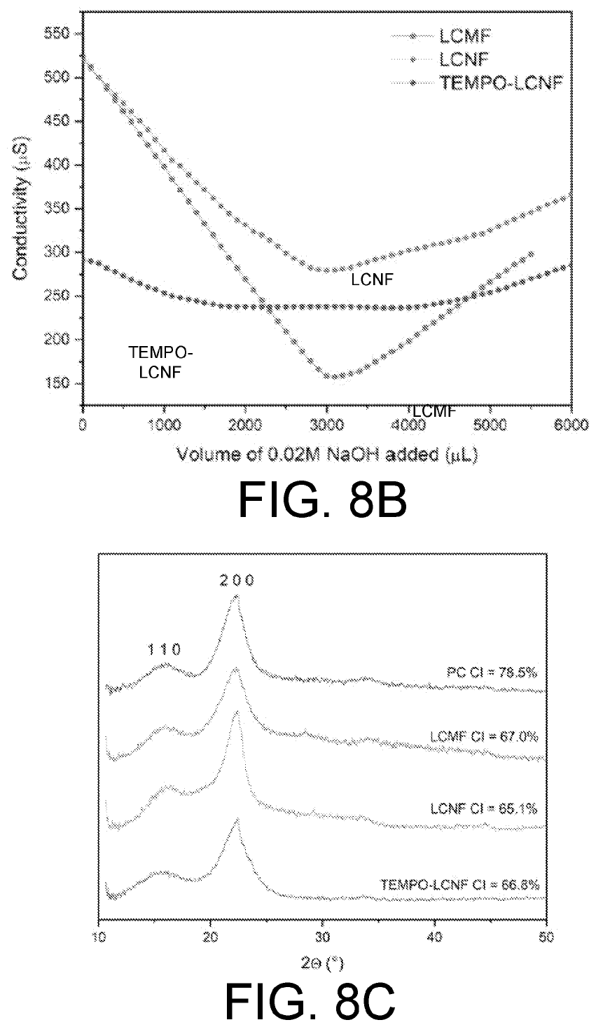

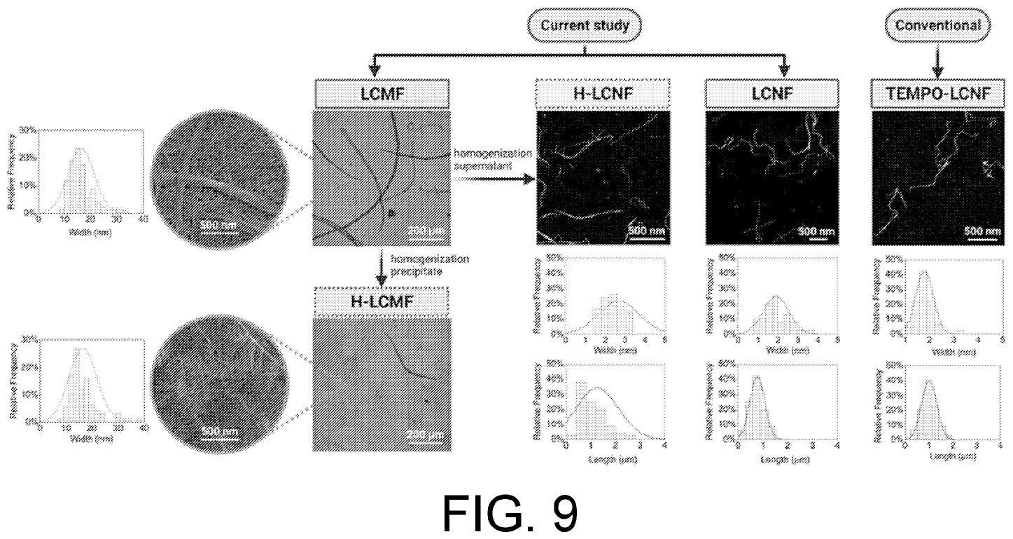

FIG. 7 illustrates optical transmittances at 660 nm of various compositions described in this Example. FIG. 8A illustrates FTIR spectra showing specific chemical bonds of lignocellulosic fibrils and their respective charge density (CD) values. CD values were calculated based on the conductometric titration curves illustrated in FIG. 8B. FIG. 8B illustrates example conductometric titration curves of different samples. The curve region showing a conductivity plateau is associated with the quantity of weak carboxylic acid groups present in the sample and therefore is related to the oxidation degree. Charge density was calculated based on the NaOH volume consumed in the plateau region. FIG. 8C illustrates X-ray diffraction spectra and corresponding CI of different samples. X-ray diffraction analysis was performed to assess the effect of both pretreatments on the crystallinity of WS fibers.

After the mechanical treatments, the lignocellulosic fibrils (nano and micro) formed homogeneous gel-like suspensions with good colloidal stability (FIG. 7 inset), while the PC was unstable and quickly sedimented. Suspension stability can be attributed to several factors, including small fibril widths, higher surface area, and electrostatic stabilization due to charge repulsion (Kaffashsaie, E., et al. (2021), Carbohydrate Polymers, 262, Article 117938). These results demonstrate that the pretreatment step (either PAA or TEMPO) was relevant to obtaining fibrils with the appropriate morphology and surface chemistry to form stable aqueous dispersions. Furthermore, the fact that PAA pretreated fibrils (LCMF, LCNF, H-LCMF, and H-LCNF) presented good colloidal stability, even though their charge density was considerably lower than that of TEMPO-LCNF (FIG. 8A), can be attributed to their high hemicellulose content (Table 1). Because hemicelluloses improve fibrillation and contribute to colloidal stability by both coulombic (glucuronic acid groups in hemicellulose that provide negative charge) and steric repulsions (bulky side chains of hemicellulose that prevent cellulose fibers from aggregating), the mild process conditions employed in the present process were essential to keep as much hemicellulose as possible in the final product and enable colloidal stability of the lignocellulosic fibrils' suspensions even at low charge densities.

FIG. 7 also shows the optical transmittance spectra of the different lignocellulosic fibrils' suspensions. Light transmittance percentage can be correlated to the size of the fibrils dispersed, where larger fibrils scatter more light, resulting in lower transmission values (Espinosa, E., et al. (2017), Cellulose, 24(6), 2605-18). LCMF and H-LCMF exhibited a milk-white appearance and, consequently, had the lowest light transmittances at 660 nm (24% and 11%, respectively) due to the presence of larger light-scattering fibrils. In contrast, the much higher transmittance of LCNF and H-LCNF (90% and 88%) indicates a smaller fibril size. TEMPO-LCNF presented similar behavior as LCNF and H-LCNF in suspension, with light transmittance of 88%, indicating that these fibrils are in the same size range.

FTIR spectra showing specific chemical bonds of the lignocellulosic fibrils, as well as their CD values obtained by conductometric titration, are shown in FIG. 8A. While the PAA oxidation mechanism targets the reducing end-groups in polysaccharides, TEMPO oxidation targets the C6 hydroxyl groups in the cellulose fibers (Isogai, A., et al. (2011), Nanoscale, 3(1), 71-85), and C6 hydroxyl groups are present in considerably larger numbers relative to reducing end-groups. For this reason, TEMPO-LCNF showed the highest CD (1088 μmol g⁻⁴) among the samples, while PAA pretreated samples showed overall lower CD ranging from 105 to 266 μmol g⁻¹. LCNF/H-LCNF presented higher CD than LCMF/H-LCMF due to their smaller fiber size and higher surface area. The CD values obtained for PAA pretreated fibers are consistent with those in the literature, where spruce holo-fibers treated with PAA showed CD varying from 200 to 270 μmol g⁻¹ (Yang, X., et al. (2018), Biomacromolecules, 19(7), 3020-29; Yang, X., et al. (2020), ACS Nano, 14 (1), 724-35). Furthermore, CD values can be correlated with specific bonds in the FTIR spectra shown in FIG. 8A. The primary peak at 1601 cm⁻¹ and the small shoulder at 1730 cm⁻¹ are attributed to the C—O stretching of carboxyl groups (Espinosa, E., et al. (2017), Cellulose, 24(6), 2605-18; Okita, Y. et al. (2009), Holzforschung, 63(5), 529-35; Tang, Z., et al. (2017), Polymers, 9(9), 3-4; Yang, X., et al. (2020), ACS Nano, 14 (1), 724-35). These peaks are more dominant in TEMPO-LCNF, therefore being proportional to its higher CD value. The absorption band at 1642 cm⁻¹ can be attributed to the C—O stretching of uronic acid carboxyl groups present in hemicellulose (Sanchez, R., et al. (2016), International Journal of Biological Macromolecules, 92, 1025-33; Zhang, L., et al. (2017). Energy and Fuels, 31(10), 10916-23). This peak is more visible in PAA pretreated samples, consistent with the higher hemicellulose content of the PAA pretreated pulp relative to TEMPO pretreated pulp (Table 1).

While previous studies have also performed TEMPO oxidation of agricultural residues, the resulting CD may vary drastically with the type of feedstock, lignin content (which is dependent on the delignification process), and NaClO charge employed during TEMPO oxidation. Both higher NaClO charges and lower lignin content positively correlate with the degree of oxidation during TEMPO pretreatment (Jiang, F. et al. (2013), RSC Advances, 3(30), 12366-75; Ma, P. & Zhai, H. (2013) BioResources, 8(2), 4396-05; Morcillo-Martin, R., et al. (2022), Biomolecules, 12, 232). For instance, pure cellulose isolated from rice straw presented a CD of approximately 1680 μmol g⁻¹ after TEMPO oxidation with 10 mmol NaClO (Jiang, F. et al. (2013), RSC Advances, 3(30), 12366-75), while lignin-containing wheat straw pulp presented a much lower charge of 362 μmol g⁻¹ after TEMPO oxidation with 5 mmol NaClO (Espinosa, E., et al. (2017), Cellulose, 24(6), 2605-18). Comparing the present study results with the latter reference (both used WS as feedstock and mild pulping as delignification method) demonstrates that the TEMPO-LCNF of this Example showed a greater CD of 1088 μmol g⁻¹ because of the higher NaClO charge of 10 mmol utilized in this study.

TABLE 3
Structural and morphological characteristics (crystallinity index, fiber
width and length, and fiber aspect ratio) of lignocellulosic fibrils.

| | Crystallinity | Fiber width | Fiber length | Fiber aspect |
|---|---|---|---|---|
| | Index (%) | (nm) | (μm) | ratio |
| LCMF | 67.0 | 16.4 ± 5.1 | — | — |
| H-LCMF | 70.8 | 16.1 ± 5.3 | — | — |
| LCNF | 65.1 | 1.9 ± 0.6 | 0.77 ± 0.29 | 405 |
| H-LCNF | 65.5 | 2.7 ± 1.0 | 1.09 ± 0.76 | 404 |
| TEMPO-LCNF | 66.8 | 1.8 ± 0.4 | 1.01 ± 0.32 | 561 |

Table 3 summarizes the different lignocellulosic fibrils' structural and morphological characteristics (crystallinity index (CI), fiber width and length, and fiber aspect ratio). The crystalline structure of fibrils was assessed based on XRD results. The effect of both pretreatments on the crystallinity of WS fibers was evaluated by comparing the CI of PAA pretreated and TEMPO pretreated fibrils (Table 3) with that of PC (FIG. 8C). PC showed a higher CI of 78.5%, while PAA pretreated fibrils (LCMF, LCNF, H-LCMF, and HLCNF) had CI ranging from 65 to 71% and TEMPO-LCNF had a CI of 67%. The reduction in CI after TEMPO pretreatment can be explained by a change in the cellulose crystalline structure into a disordered structure due to the formation of sodium glucuronosyl units by oxidation (Espinosa, E., et al. (2017), Cellulose, 24(6), 2605-18; Puangsin, B. et al. (2013), International Journal of Biological Macromolecules, 59, 208-13; Sanchez, R., et al. (2016), International Journal of Biological Macromolecules, 92, 1025-33). As for the PAA pretreatment, the decrease in CI can be explained by structural swelling of WS fibers and dissolution of crystalline cellulose during the reaction (Gharpuray, M. M. (1983), Biotechnology and Bioengineering, 25(1), 157-72). The similarity between the CI of LCMF, LCNF, and TEMPO-LCNF is consistent with previous studies finding TEMPO-LCNF from spruce had a CI of 64% and holo-CNF (i.e., fibers that went through peracetic acid pretreatment) had a CI of 65% (Yang, X., et al. (2020), ACS Nano, 14 (1), 724-35).

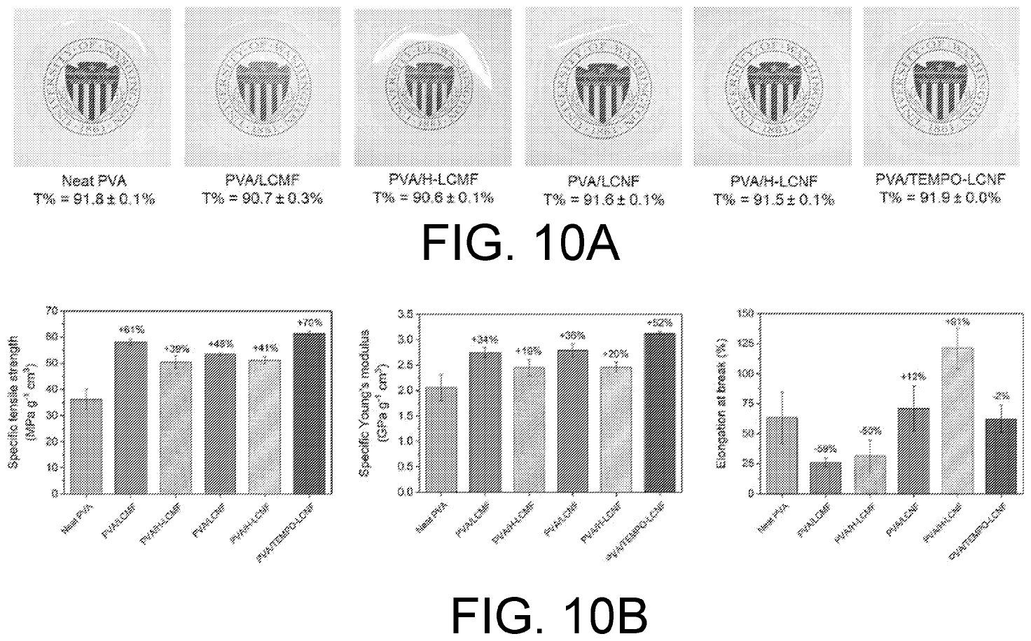

FIG. 9 illustrates microscope images and size distribution of different lignocellulosic fibrils in this Example. LCMF and H-LCMF show both optical microscope and SEM images; LCNF, H-LCNF, and TEMPO-LCNF show AFM images. FIG. 9 illustrates microscopy images (including optical microscopy, SEM, and AFM) and size distribution curves of all lignocellulosic fibrils compared in this study. Low magnification optical microscopy images of LCMF and H-LCMF revealed that the homogenization step drastically reduced the number of large unfibrillated fibers, resulting in a more homogeneous sample. The morphology of LCMF and H-LCMF were further assessed using SEM, confirming a uniform network of long and entangled microfibrils. Individual LCMF and H-LCMF microfibrils had similar average widths of 16.4 and 16.1 nm, respectively (FIG. 9, Table 3), comparable to other microfibrils widths reported in the literature (Henriksson, Henriksson, Berglund, & Lindstrom, 2007; Lu et al., 2008; Meng et al., 2016; Siro & Plackett, 2010).

LCNF showed similar morphology to conventional TEMPO-LCNF while undergoing a milder pretreatment. The fibril size of about 2 nm wide and 1 μm long is characteristic of individual elementary fibrils (Meng et al., 2016). After homogenization of the LCMF fraction, the HLCNF obtained had comparable morphology to both LCNF and TEMPOLCNF (FIG. 9, Table 3), but with a much higher separation yield than LCNF. TEMPO-LCNF exhibited the highest aspect ratio with a narrow width and length size distribution, while LCNF and H-LCNF had lower aspect ratios (405 and 404, respectively) and wider size distributions. H-LCNF presented a broader, right-skewed distribution than its non-homogenized counterpart, suggesting that microfluidizer-induced mechanical defibrillation yields both short and thin, as well as long and wide fibrils. Similar results have been reported by Yang et al. (Yang et al., 2020), where holo-CNF prepared by microfluidizer presented a wider fibril size distribution than those prepared using a blender. The more heterogeneous nature of H-LCNF may be attributed to a) the mild PAA pretreatment employed, resulting in low degree of oxidation, and/or b) mechanical exfoliation of the fiber's surface during the homogenization step, releasing fibrils of varied sizes.

The lignocellulosic fibril sizes obtained in the present study, especially LCNF and H-LCNF, are within the low range compared to previous studies on LCNF production (Liu et al., 2021), demonstrating the process's capabilities. Generally, the type of feedstock, process conditions, and mechanical fibrillation techniques utilized can impact the size of resulting fibrils (Dufresne, 2013). For instance, the process adopted by Rojo et al. generated LCNF with widths ranging from 16 to 44 nm depending on the fibers' lignin content (Rojo et al., 2015).

Espinosa et al. produced LCNF from WS with widths varying from 6 to 14 nm via soda pulping and different pretreatment methods (TEMPO oxidation, enzymatic hydrolysis, and purely mechanical) followed by high-pressure homogenization (Espi-nosa et al., 2017). Bian et al. produced LCNF from WS and pulp waste with widths ranging from 12 to 47 nm using concentrated p-toluene-sulfonic acid hydrolysis, disk grinding, alkaline peroxide bleaching, and dialysis (Bian et al., 2019). Finally, the TEMPO-LCNF produced from WS in this study showed similar morphology as those prepared from hardwood bleached pulp (Saito et al., 2007). It should also be noted that the large variance in nanofibril widths reported in the literature can be associated with the broad use of the terms “nanofibril” and “nanocellulose,” which may encompass any fibrils that are <100 nm wide (Isogai et al., 2011).

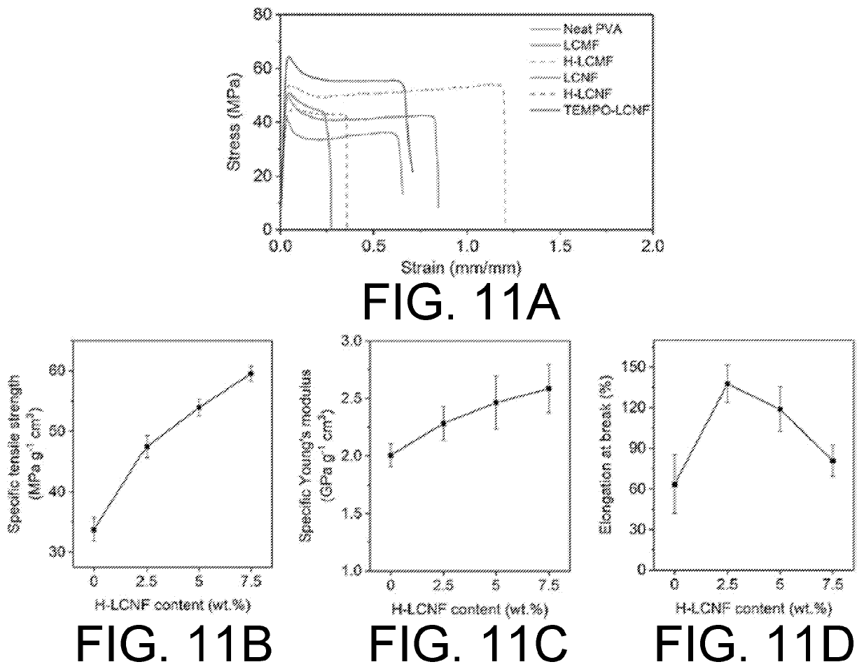

FIGS. 10A and 10B illustrate example stability comparisons of different prepared lignocellulosic fibrils. FIG. 10A illustrates TGA curves with the residual mass percentage at 600° C.; FIG. 10B illustrates derivative thermogravimetric (DTG) curves with Tmₐₓ values.

The thermal stability of the different lignocellulosic fibrils were tested by thermogravimetric analysis (TGA). The temperature at which maximum degradation rate occurs (Tmₐₓ) and the residual mass percentage at 600° C. are presented in FIGS. 10A and 10B. For all samples, a small weight loss (i.e., <10%) was observed at temperatures up to 200° C. caused by evaporation of residual water in the fibers, while the most significant weight loss was observed between 200 and 400° C.

TEMPO-LCNF clearly presented a different thermal degradation mechanism than PAA pretreated fibrils. TEMPO-LCNF had two prominent degradation peaks (FIG. 10A) at lower temperatures (243° C. and 295° C.) and presented the highest residual mass (31%) (FIG. 10A). The primary reason for this behavior may be the presence of more carboxylic acid groups (higher CD) in TEMPO-LCNF compared to the other samples (Espinosa et al., 2017; Kaffashsaie et al., 2021; Meng et al., 2016; Yang et al., 2020), as seen in previous results in FIG. 8A. Those groups are less thermally stable compared to intra-chain bonds of cellulose, thus reducing the overall resistance to thermal degradation of the fiber. The first degradation peak (243° C.) can be correlated with the primary degradation of TEMPO-LCNF catalyzed by the acid groups formed during the oxidation. The second degradation peak (295° C.) can be associated with the slow charring process of solid residuals (Wang, Ding, & Cheng, 2007). The decomposition of TEMPO-LCNF at a wide range of lower temperatures promoted the formation of char residues (Wang et al.) as seen by its higher residual mass percentage.

In contrast, other lignocellulosic fibrils produced via PAA pre-treatment presented only one prominent degradation peak and higher thermal stability than TEMPO-LCNF (FIG. 10B), which can be correlated to the presence of fewer oxygen groups, as mentioned earlier, and to the higher lignin content of PAA pretreated samples. The latter observation is consistent with previous research in the literature, where a higher lignin content was found to improve the thermal stability of cellulose nanofibrils (Nair & Yan, 2015). Both microfibrils (LCMF and H-LCMF) were the most thermally stable (Tmₐₓ at about 350° C.), which can be attributed to their larger fiber dimensions, the presence of possible bundles, and their higher crystallinity, which would provide higher resistance to chain scission. Furthermore, despite having similar morphologies, both nanofibrils produced via PAA pretreatment (LCNF and H-LCNF) showed higher thermal stability than TEMPO-LCNF, with Tmₐₓ approximately 90 C higher due to lower CD and higher lignin content.

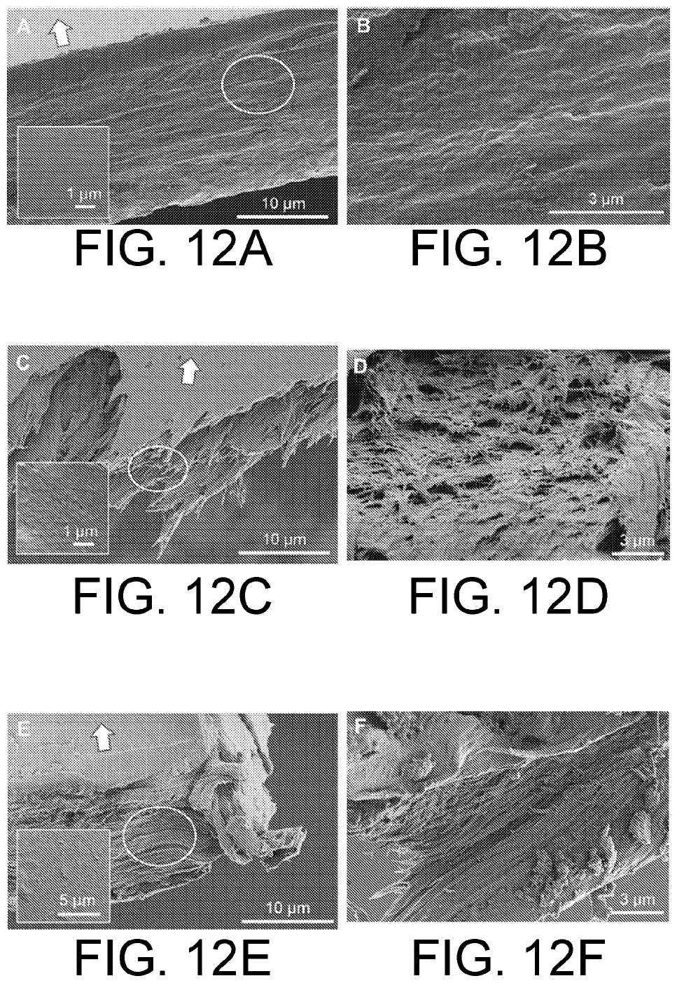

FIGS. 11A to 11D illustrate examples of PVA composite films. FIG. 11A illustrates photographs of PVA composite films and optical transmittance values at 660 nm, FIG. 11B illustrates properties (specific tensile strength, specific Young's modulus, and elongation at break) of the example PVA composite films; FIG. 11C illustrates stress-strain curves of the example PVA composite films; and FIG. 11D illustrates mechanical properties of example PVA/H-LCNF composites as a function of H-LCNF content.

As illustrated in FIG. 11A, adding 5 wt % lignocellulosic fibrils as a reinforcing agent in PVA films had minimal effects on light transmittance compared to neat PVA. Then, the reinforcing effect of the different lignocellulosic fibrils on the mechanical properties of PVA composite films was assessed by tensile testing. The test specimens' thickness and density are shown Table 4:

TABLE 4
Tensile test specimen's thickness, density,
and resulting mechanical features.

| | | | Specific tensile |
|---|---|---|---|
| | Thickness | Density | strength |
| | (μm) | (g cm⁻³) | (MPa g⁻¹ cm³) |
| Neat PVA | 39.0 ± 0.8 | 1.26 ± 0.04 | 36.2 ± 3.8 |
| PVA/LCMF | 79.1 ± 2.4 | 0.86 ± 0.03 | 58.2 ± 1.2 |
| PVA/H-LCMF | 74.6 ± 6.7 | 0.89 ± 0.03 | 50.4 ± 2.3 |
| PVA/LCNF | 52.6 ± 0.6 | 1.16 ± 0.04 | 53.5 ± 0.6 |
| PVA/H-LCNF | 57.8 ± 2.0 | 1.18 ± 0.05 | 51.2 ± 1.4 |
| PVA/TEMPO-LCNF | 58.2 ± 4.8 | 1.06 ± 0.03 | 61.4 ± 0.8 |

| | Specific Young's | Elongation | Fracture |
|---|---|---|---|
| | modulus | at break | toughness |
| | (GPa g⁻¹ cm³) | (%) | (MJ/m³) |
| Neat PVA | 2.1 ± 0.3 | 63.4 ± 21.6 | 22.3 |
| PVA/LCMF | 2.7 ± 0.1 | 26.1 ± 3.7 | 11.7 |
| PVA/H-LCMF | 2.5 ± 0.2 | 31.5 ± 13.2 | 15.0 |
| PVA/LCNF | 2.8 ± 0.1 | 71.0 ± 18.8 | 35.0 |
| PVA/H-LCNF | 2.5 ± 0.1 | 121.1 ± 16.7 | 61.4 |
| PVA/TEMPO- | 3.1 ± 0.0 | 62.3 ± 11.5 | 38.3 |
| LCNF | | | |

FIG. 11B shows the specific tensile strength, FIG. 11C shows specific Young's modulus, and FIG. 11D shows elongation at break of different PVA composite films and their per-centage increase or decrease related to neat PVA. It can be seen that considerable improvements both in specific tensile strength and specific Young's modulus were achieved for all reinforced composites, indicating that the lignocellulosic fibrils (regardless of their type) exhibited good interfacial interactions with the PVA matrix, resulting in composites with increased strength and stiffness due to good dispersion and strong interactions between the fibrils and PVA (Espinosa et al., 2019; Lee et al., 2020).

PVA/LCMF showed a 61% increase in specific tensile strength compared to neat PVA, while PVA/LCNF showed a 48% increase. This difference is associated with LCMF's stronger fiber network and greater fiber size ratio than LCNF. The longer LCMF fibers allow increased matrix/fibril interaction and thus more effective load transfer between the polymer backbone and cellulose fiber. The superior specific tensile strength of PVA/TEMPO-LCNF compared to all other samples can be explained by its higher CD, where the extensive surface functionalization provided better dispersion and most effective bonding between the fibers and PVA (Kassab et al., 2020). PVA/LCMF and PVA/LCNF resulted in similar improvements in specific Young's modulus (34% and 36%, respectively), while PVA/TEMPO-LCNF resulted in the most improvement (52%), indicating that the composite's stiffness is mainly affected by CD rather than the size of the fibrils. This outcome was expected since Young's modulus can be related to the bonding between the different components in the composite, therefore being more susceptible to the material's chemical characteristics than its physical morphology.

The majority of the reinforced composites exhibited either similar or lower fracture strain values than that of neat PVA, with the most significant reduction in elongation at break observed for composites containing LCMF (−59%), which was the sample with the highest strength and modulus increases across the PAA pretreated fibrils. The higher fibril size of LCMF, as mentioned above, allows more interactions between the polymer and cellulose chains, which strengthens and stiffens the composite, but reduces the amount of available chain sliding upon loading, leading to less elongation to break. This trend was expected considering that the addition of rigid cellulosic fillers to polymer matrices can reduce the extent of plastic deformations, decreasing elongation at break and toughness properties (Espinosa et al., 2019; Lee et al., 2020). Surprisingly, the PVA/H-LCNF specimens did not follow this behavior and showed a simultaneous strengthening and toughening of the polymer matrix compared to neat PVA, with augmentations in tensile strength and elongation at break of 41% and 91%, respectively (FIGS. 11B and 11C). PVA/H-LCNF presented the greatest fracture toughness value of 61.4 MJ/m³, a 175% augmentation related to neat PVA (22.3 MJ/m³ fracture toughness) (Table 4). This outcome might be attributed to the right-skewed size distribution and more heterogeneous nature of H-LCNF, improving filler dispersion and network structure in the PVA matrix. Since H-LCNF fibers show a larger fiber length distribution, they could sustain more chain unentaglement and/or sliding when subjected to mechanical loads compared to samples with tighter length distributions.

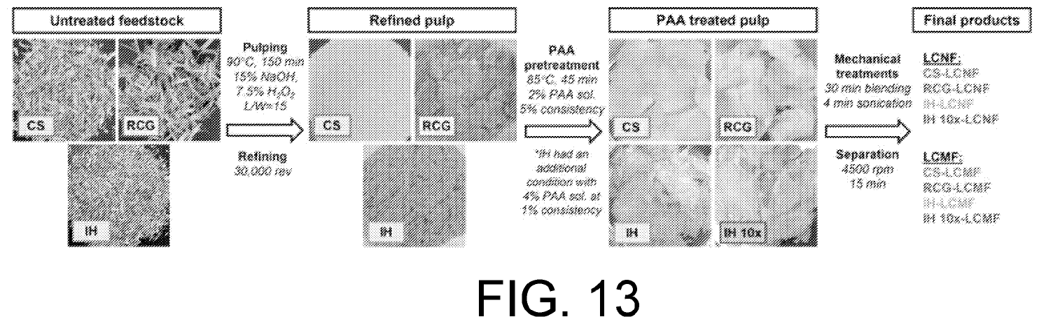

To further investigate the reinforcing mechanism of PVA with the addition of different reinforcing agents, the fracture surfaces of PVA composites were examined by SEM. FIGS. 12A to 12F illustrates representative SEM images of fractured surfaces at low and high magnifications of various materials described in relation to this Example. FIGS. 12A and 12B illustrate images of neat PVA, FIGS. 12C and 12D illustrate images of PVA/H-LCMF, and FIGS. 12E and 12F illustrate images of PVA/H-LCNF composites. The arrows indicate the tensile load direction, while the circled areas highlight the approximated regions where the higher magnification images were taken. Insets in FIGS. 12A to 12C show the top surface of each composite film.

While it was not possible to identify the presence of individual fibrils in the matrix, the presence of either one of the reinforcing agents caused a drastic change in the deformation mechanism of PVA. Both agents caused extensive polymer fibrillation during tensile deformation, while neat PVA showed a smooth fracture surface. The observed fibrillation is seen uniformly throughout each composite, indicating that the lignocellulosic fibrils (either nano or micro) were evenly distributed within the sample. Moreover, it can be seen that the polymer matrix formed much longer and smoother fibrils before failure when reinforced with H-LCNF, suggesting a substantial ductility compared to the more abruptly fractured PVA/H-LCMF composite. The PVA/H-LCMF composite also presented some gap features in the fracture surface, indicating more debonding in the polymer matrix. These observations agree with the elongation to break results obtained for PVA/H-LCNF and PVA/H-LCMF previously shown in FIGS. 11A and 11B.

This binary reinforcing and toughening trend was further confirmed for PVA composites prepared at different H-LCNF contents (FIG. 11D). A progressive increase in tensile strength was observed at higher H-LCNF with an augmentation of 76% at 7.5 wt % H-LCNF compared to neat PVA. Similarly, the specific Young's modulus increased with the H-LCNF content, reaching a maximum of 2.6 GPa g⁻¹ cm³ at 7.5 wt % H-LCNF, which is 29% higher than neat PVA (2.0 GPa g⁻¹ cm³). This strengthening effect may be related to the load-bearing of inherently rigid cellulose nanofibrils in the polymer matrix, demonstrating good interfacial interactions between H-LCNF and PVA (Espinosa et al., 2019). Finally, the elongation at break reached its maximum at 2.5 wt % H-LCNF with a fracture strain of 138% (117% augmentation compared to neat PVA) and gradually decreased at higher H-LCNF contents, all while remaining greater than neat PVA. The observed reduction in elongation beyond possible filler aggregation at higher loadings (Espinosa et al., 2019; Liu et al., 2013).

Several studies have reported Young's modulus and tensile strength improvements at comparable CNF contents related to neat PVA (Espinosa et al., 2019; Lee et al., 2020). The CNF reinforcement in these studies, however, came at the cost of significant reductions in elongation, as substantial as −50% in some instances, making the composite extremely brittle and not suitable for practical applications. The binary reinforcing and toughening effect observed was also seen, to a lesser extent, by Kassab et al., where PVA reinforced by 5 wt % TEMPO-oxidized CNF resulted in respective increases of 36%, 60%, and 58% in elastic modulus, tensile strength, and elongation compared to neat PVA (Kassab et al., 2020). The present study showed a much greater improvement in elongation (91%) for PVA reinforced with 5 wt % H-LCNF.

This work has demonstrated that lignocellulosic nanomaterials with outstanding plastic reinforcing properties can be produced from inexpensive agricultural waste feedstock via alkaline peroxide pulping followed by mild and more environmentally friendly PAA pretreatment. The unique aspect of the materials (nanofibrils and microfibrils) produced from the agricultural residue and mild process conditions described herein is that hemicellulose and lignin components were preserved, which was crucial for improving yields. Even though mild PAA pretreatment produced nanomaterials with lower surface charge density than TEMPO oxidation, it did not negatively affect the materials' properties. All samples showed good colloidal stability in aqueous media mainly due to coulombic and steric repulsions by hemicellulose on the fibril's surface. The lower charge density and higher lignin content of PAA pretreated materials resulted in higher thermal stability. In addition, regardless of the charge density, all fibrils exhibited good dispersion in the PVA matrix, leading to improvements in mechanical properties (tensile strength and Young's modulus) of the composites—with an exceptional case of simultaneous toughening and strengthening. The present work has demonstrated a new method to produce lignocellulosic nanomaterials using an agricultural waste feedstock, advocating for more robust commercial processes that can handle other low-purity, heterogeneous raw materials. This commercially viable process could produce nanomaterials at a large scale with commodity product economics, enabling their use in high-volume applications such as bioplastics.

### Second Experimental Example

The use of agricultural waste biomass for nanocellulose production has gained interest due to its environmental and economic benefits compared to conventional bleached pulp feedstock. However, there is still a need to establish robust process technologies that can accommodate the variability of waste feedstocks and to understand the effects of feedstock characteristics on the final nanofiber properties. Here, lignocellulosic nanofibers with unique properties are produced from various waste biomass based on a simple and low-cost process using mild operating conditions. The process robustness is demonstrated by diversifying the feedstock. This comprehensive study provides a thorough examination of the influence of the feedstocks' physico-chemical characteristics on the conversion treatment, including process yield, degree of delignification, effectiveness of nanofibrillation, fiber morphology, surface charge, and density. Results show that nanofibers have been successfully produced from all feedstocks, with minor to no adjustments to process conditions.

This Example evaluates three types of biomass waste feedstocks available in various regions across the United States, including another food crop residue (corn stover (CS)), an invasive grass species (reed canary grass (RCG)), and an industrial lignocellulosic residue (industrial hemp (IH)). CS is an agricultural crop residue comprising the leftover stalks and leaves from corn production. RCG (Phalaris arundinacea L.) is a lignocellulosic perennial crop that can grow on marginal lands unsuitable for food crops (Jensen, E. F. et al., Perennial Grasses for Bioenergy and Bioproducts, 2018; Volume 2, pp. 153-73)

IH (Cannabis sativa) is a fast-growing, non-wood plant fiber crop with low water and nutrient requirements that grows in various environmental conditions (Marrot, L. et al., Waste Biomass Valoriz. 2022, 13, 2267-85; Crini, G. et al., Environ. Chem. Lett. 2020, 18, 1451-76). Morphologically, IH stalks contain two types of fibers: bast (very long, about 10 to 20 times longer than fibers from hardwoods, softwoods, and agricultural residues) and core fibers (shorter fibers with similar physical characteristics to hardwood fibers) (Correia, F. et al., J. Wood Chem. Technol. 2001, 21, 97-111). Bast fibers are commonly used in ropes, paper, textiles, and composites, while core fibers are used in paper, construction materials, biofuels, and others (Crini, G. et al., Environ. Chem. Lett. 2020, 18, 1451-76).

The three biomass feedstocks selected in this study (CS, RCG, and IH) have great potential for high-value biomaterial applications, either due to their high availability, invasive nature, low-value market, or low water and nutrient requirements. In this work, they are used to produce high-value LCNF. The present work aims to (1) assess the robustness of the conversion process by using agricultural waste feedstocks from various plant species and (2) elucidate how the specific chemical and physical characteristics of the biomass feedstocks affect the properties of the final products.

### Materials and Methods

Three biomass feedstocks were used in this study. CS chopped to 6 mm particle size was sourced from Forest Concepts in Auburn, WA. RCG bales were sourced from farms in Lewis County, WA, and cut into half-inch pieces using a hand pruner. IH stalks were sourced from the Squaxin Island tribe, WA, and chopped to 2 mm particle size. All biomass feedstocks were air-dried and stored in plastic buckets until use.

The following chemicals were used for the reaction steps: 32% (w/w) peracetic acid (Sigma Aldrich, Saint Louis, MO, USA), 50% (w/w) sodium hydroxide (VWR Chemicals BDH), 50% (w/w) hydrogen peroxide (Cascade Columbia Distribution), diethylenetriamine pentaacetic acid (DTPA) 98+% (Acros Organics, Fisher Scientific, Hampton, NH, USA).

The three biomass feedstocks underwent alkaline peroxide pulping following the same procedure utilized in the First Example. After pulping, the samples were vacuum filtered, and the pulps were extensively washed with DI water. Finally, the washed pulps were refined using a laboratory PFI mill for 30,000 revolutions, resulting in refined pulps.

The refined pulps were submitted to PAA pretreatment based on the procedure of the First Example with some modifications. First, the refined pulps were mixed with PAA solution (2 wt. %) at pH 4.8 in a plastic bottle to achieve 5% pulp consistency, and the reaction was carried out at 85° C. for 45 min in a water bath. Due to IH's different physico-chemical characteristics and delignification behavior compared to the other feedstocks (as seen in the results and discussion section), an additional PAA pretreatment condition was carried out for the IH sample with 4 wt. % PAA solution and 1% pulp consistency (resulting in a PAA charge approximately 10 times higher than the original reaction condition), producing an additional sample named IH 10×. Samples were vacuum filtered, and the PAA-treated pulps were thoroughly washed with 0.01 M NaOH followed by DI water.

The different PAA-treated pulps were fibrillated under the same conditions using a blender (30 min) at 0.4 wt. % consistency, followed by homogenization with a horn ultrasonicator operated at 100% amplitude and 0.1 wt. % consistency for 4 min. The samples were then centrifuged (4500 rpm, 15 min) to separate two product fractions: supernatant including LCNF, and precipitate including LCMF. In this Example, the term lignocellulosic nanofibers will be used to refer to both LCNF and LCMF fractions in a general sense. The LCNF suspensions were concentrated by vacuum-rotary drum evaporation at 90° C. Samples were stored in glass bottles at room temperature until use.

The chemical composition of untreated biomass feedstocks, alkaline peroxide pulps, and PAA-treated pulps was assessed. The carbohydrates, acidic/uronic acids, and lignin content (including both acid-soluble and acid-insoluble lignin) were quantified. Ash content was measured gravimetrically (Sluiter, A. et al. Determination of Ash in Biomass: Laboratory Analytical Procedure (LAP). 2008), and total extractives content was determined by water and ethanol Soxhlet extraction with a 12 h reflux time (Sluiter, A. et al., Determination of Extractives in Biomass: Laboratory Analytical Procedure (LAP). 2008; NREL/TP-510-42619).

The total mass yield after pulping and PAA pretreatment was determined gravimetrically by comparing the OD mass of pulp obtained after each process with that of the untreated biomass, as seen in Equation (1), which is an equation to calculate mass yield (%):

$$( Pulp mass after each reaction ( g ) ) / ( Mass of untreated biomass ( g ) ) \times 100 \qquad ( 1 )$$

The recoveries of holocellulose (cellulose and hemicellulose) and lignin components after pulping and PAA pretreatment were calculated by correlating the mass yield and chemical composition at each stage to that of the untreated biomass, as seen in Equation (2), which is an equation to calculate component recovery (%):

$$( Amount of component in pulp ( \% ) \times Mass yield ( \% ) ) / ( Amount of component in untreated biomass ( \% ) ) \qquad ( 2 )$$

The product separation yield was determined by centrifugation. Two fractions of products were obtained after centrifugation: supernatant LCNF and precipitate LCMF. The product separation yields, expressed as percentages, were calculated by the OD weight ratio of each product fraction to the pre-centrifugation suspension, as shown in Equation (3), which is an equation to calculate separation yield:

$$Seperation yield ( \% ) = ( post - centrifugation LCNF or LCMF dry mass ( g ) ) / ( pre - centrifugation LCNF + LCMF dry mass ( g ) ) \times 100 \qquad ( 3 )$$

Optical transmittance of aqueous lignocellulosic nanofibers suspensions at 0.2 wt. % concentration was conducted using UV/VIS/NIR Spectrophotometer in the visible region (from 400 to 800 nm) at a scan resolution of 1 nm. DI water was used as a blank. The optical light transmittance was evaluated using the percent transmittance at 660 nm (Espinosa, E. et al., Int. J. Biol. Macromol. 2019, 141, 197-206).

The surface charge density of different lignocellulosic nanofibers was determined by conductometric titration based on the method described by Besbes et al. (Besbes, I. et al., Carbohydr. Polym. 2011, 84, 975-83) with minor modifications. Briefly, 0.5 mL of 0.1 M HCl was added to 50 mL of 0.1 wt. % sample suspension and mixed for 10 min to protonate the carboxyl groups. Then, a titration was performed with 0.02 M NaOH at 100 μL increments, and the conductivity values were measured using a conductivity meter. The charge density (μmol COOH/g) was determined according to Equation (4), where V1 is the volume of NaOH required to neutralize the excess HCl, and the difference between V2 and V1 is the volume of NaOH used to neutralize the carboxylic acids.

$$Charge density = ( ( V 2 - V 1 ) \times [ NaOH ] ) / ( sample oven dry weight ) \qquad ( 4 )$$

Crystallinity index (CI) of different lignocellulosic nanofibers was determined by X-ray diffraction (XRD) using a Bruker D8 Discover coupled with a Pilatus 100K large-area 2D detector and a Cu Kα radiation generated at 50 kV and 1 mA. Diffractograms of neat films were taken over a 2θ angular range of 10-50° with 0.02° steps. The CI was calculated based on the Segal method, as shown in Equation (5):

$$CI ( \% ) = ( It - Ia ) / It \qquad ( 5 )$$

where It is the intensity of the crystalline peak (2 0 0) at 2θ=22.7° and Ia is the intensity of the amorphous peak (1 1 0) at 2θ=18° (Nam, S. et al., Carbohydr. Polym. 2016, 135, 1-9).

Specific functional groups within the different materials were characterized by Fourier-transform infrared spectroscopy (FTIR). Infrared spectra were analyzed using FT-IR Prestige-21 spectrometer (Shimadzu) coupled with a DLATGS detector attached to MIRacle ATR. The spectra were collected at ambient conditions in [550-4000] cm⁻¹ range with a resolution of 4 cm⁻¹ and from an accumulation of 40 scans. The spectra obtained were normalized by dividing all absorbance values by the largest absorbance value (based on the highest cellulose peak centered around 1026-1028 cm⁻¹).

Nanofiber morphology was examined by scanning electron microscopy (SEM) and atomic force microscopy (AFM) techniques. AFM images of LCNFs were collected using a Bruker ICON AFM in contact mode and a scan rate of 1 Hz. LCNF suspensions were diluted to 0.001 wt. % with DI water and bath sonicated for 5 min to promote dispersion. An amount of 100 μL of LCNF was drop-casted onto a freshly cleaved mica disc previously coated with 50 μL of L-lysine, rinsed with DI water, and air-dried. The LCNF width and length were computed from at least 20 measurements of individual fibrils. SEM images of LCMFs were collected using an Apreo S (Thermofisher Scientific) coupled with a standard ETD in-chamber SE detector and a T2 in-column SE detector. LCMF suspensions were diluted to 0.01 wt. % with DI water and bath sonicated for 3 min; then, 10 μL of sample was drop-casted onto a clean SiO₂ wafer. Before imaging, the samples were sputter-coated with a 4 nm thick platinum layer using a Leica EM ACE600 coater. Operating conditions were at high vacuum with an acceleration voltage of 2 kV and beam current of 6.3 pA. The LCMF width was computed from at least 20 measurements of individual fibrils. Unfortunately, it was not possible to measure LCMF fiber length due to the entanglement of fibers in the SEM imaging method.

### Results and Discussion

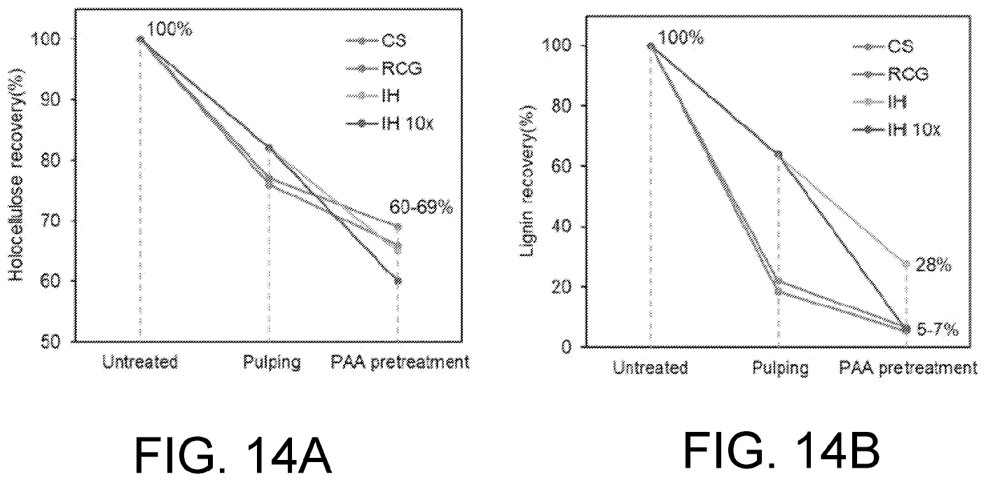

FIG. 13 illustrates a summary of process steps to produce lignocellulosic nanofibers (LCNF and LCMF) from different biomass feedstocks. The same colors used in this figure to represent the different samples were used throughout the entire work. Particularly for IH biomass, an additional PAA pretreatment was performed at higher PAA loading, producing IH 10× sample.

FIG. 13 summarizes the process steps to produce lignocellulosic nanofibers from CS, RCG, and IH. First, each biomass feedstock underwent alkaline peroxide pulping and refining, producing refined pulps. Then, the pulps underwent PAA pretreatment, generating PAA-treated pulps. In the specific case of IH, an additional PAA condition was carried out containing 10 times higher PAA charge during the reaction, producing IH 10× treated pulp. Finally, all PAA-treated pulps underwent mechanical fibrillation, homogenization, and separation, each generating to product fractions: LCNF and microfibrils LCMF. The chemical composition of each untreated biomass and their respective pulps was assessed after each reaction step, and the resulting lignocellulosic nanofibers (both LCNFs and LCMFs) were characterized (optical transmittance, surface chemistry, crystallinity, and morphology) and compared.

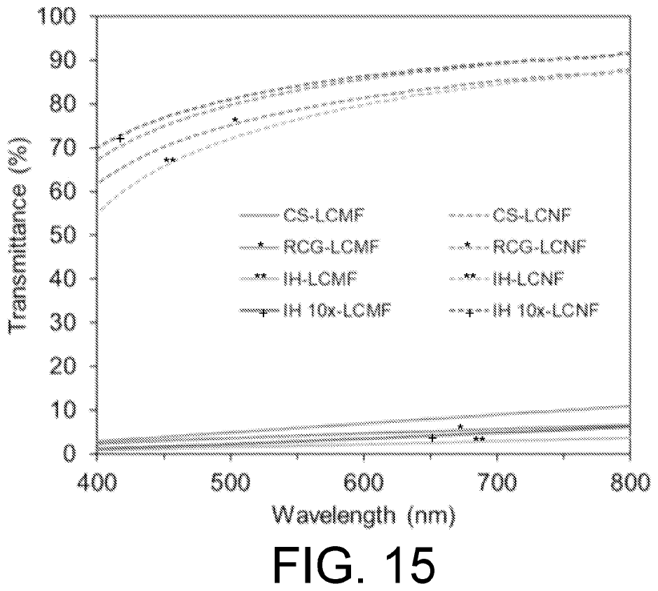

FIGS. 14A and 14B illustrate recovery percentages of (FIG. 14A) holocellulose and (FIG. 14B) lignin components after pulping and PAA pretreatment related to untreated biomass. The complete recovery results are shown in Table 5:

TABLE 5
Holocellulose and lignin recovery after alkaline peroxide
pulping and PAA treatment related to the untreated biomass.

| | | Holocellulose recovery (%) | Lignin recovery (%) |
|---|---|---|---|
| Pulp | CS | 76 | 19 |
| | RCG | 77 | 22 |
| | IH | 82 | 64 |
| PAA | CS | 66 | 5 |
| Pretreated | RCG | 69 | 7 |
| Pulp | IH | 65 | 28 |
| | IH 10x | 60 | 6 |

The effects of pulping and PAA pretreatment reactions on the main chemical components of the different biomass feedstock are represented in FIGS. 14A and 14B. FIG. 14A displays the recovery percentages of holocellulose (corresponding to both cellulose and hemicellulose fractions), and FIG. 14B shows the recovery percentages of the lignin component. The total mass yield and complete chemical composition of each material are shown in Table 6 and the complete holocellulose and lignin recovery results are included in Table 5.

TABLE 6
Total mass yield and chemical composition of untreated
biomass feedstocks, alkaline peroxide pulps, and PAA
treated pulps of CS, RCG, and IH. In the special case
of IH, one additional PAA reaction condition was studied
employing about 10 times higher PAA charge. Chemical
composition is reported in % of oven-dry weight.

| | | Total mass | | |
|---|---|---|---|---|
| | | yield | Holocellulose ^{a} | Uronic/acetic acids |
| | | (%) | % | % |
| Untreated | CS | — | 71.9 ± 2.1 | 3.8 ± 0.2 |
| | RCG | — | 50.4 ± 0.4 | 3.1 ± 0.1 |
| | IH | — | 55.5 ± 0.2 | 5.5 ± 0.2 |
| Pulp | CS | 60.6 | 90.3 ± 0.3 | 0.0 ± 0.0 |
| | RCG | 49.0 | 79.5 ± 0.3 | 0.0 ± 0.0 |
| | IH | 64.4 | 70.7 ± 3.4 | 0.0 ± 0.0 |
| PAA-Treated | CS | 50.2 | 95.0 ± 0.3 | 0.0 ± 0.0 |
| Pulp | RCG | 40.0 | 86.7 ± 2.5 | 0.0 ± 0.0 |
| | IH | 44.2 | 81.3 ± 0.5 | 0.0 ± 0.0 |
| | IH 10x | 36.2 | 92.7 ± 1.0 | 0.0 ± 0.0 |

| | | Lignin | Ash | Extractives |
|---|---|---|---|---|
| | | % | % | % |
| Untreated | CS | 21.3 ± 0.2 | 3.4 ± 0.1 | 7.8 ± 0.1 |
| | RCG | 21.5 ± 0.2 | 8.2 ± 0.1 | 29.6 ± 0.1 |
| | IH | 19.3 ± 0.2 | 5.2 ± 0.0 | 16.5 ± 0.3 |
| Pulp | CS | 6.5 ± 0.2 | 1.3 ± 0.2 | 2.1 ± 0.5 |
| | RCG | 9.7 ± 0.2 | 2.3 ± 0.1 | 4.2 ± 0.1 |
| | IH | 19.1 ± 0.1 | 3.5 ± 0.2 | 3.0 ± 0.3 |
| PAA-Treated | CS | 2.3 ± 0.3 | <0.1 | NM |
| Pulp | RCG | 3.6 ± 0.1 | 0.2 ± 0.0 | NM |
| | IH | 12.0 ± 0.2 | 2.2 ± 0.1 | NM |
| | IH 10x | 3.1 ± 0.1 | 1.5 ± 0.0 | NM |

The goal of mild alkaline peroxide pulping was to partially remove lignin, enabling fibrillation while keeping most holocellulose intact for higher yields. Accordingly, FIG. 14A shows that more than 76% of holocellulose was preserved in all feedstocks after pulping, demonstrating a low carbohydrate loss during the reaction. RCG had the lowest total mass yield (49%) after pulping compared to the other feedstocks due to its high extractives and ash content (supporting information, table Si), which were removed during processing. The RCG mass yield could be improved further by using only the stem portion of the feedstock since the leaves contain the most ash and extractives (Finell, M. The Use of Reed Canary-Grass (Phalaris arundinacea) as a Short Fibre Raw Material for the Pulp and Paper Industry. Doctoral Thesis, Swedish University of Agricultural Sciences, Umea, Sweden, 2003).

Extensive delignification during pulping was observed for both CS and RCG, with similar delignification percentages ranging from 78-81% (i.e., 19-22% lignin recovery), while IH had the lowest delignification of only 36% (i.e., 64% recovery) (FIG. 14B). The low delignification observed for IH is in accordance with a previous study by Wawro et al., where the authors reported little effect on the lignin content of IH fibers after mild NaOH treatment (90° C. for 5 h) (Wawro, A. et al., Appl. Sci. 2019, 9, 5348). The discrepancy in the extent of delignification of IH compared to the other feedstocks can be explained by its distinctive physical characteristics. IH stalks have a similar physical structure as woody biomass, and alkaline pulping treatments performed on IH biomass are typically carried out at much higher temperatures and pressure (typically 120-180° C.) (Correia, F. et al., J. Wood Chem. Technol. 2001, 21, 97-111; Zhao, J. et al., Fuel 2020, 281, 118725), similar to the conditions used in hardwood pulping. The mild pulping condition employed in the present study (i.e., 90° C., atmospheric pressure) only solubilized the highly reactive lignin in IH, such as phenolic α-O-4 linkages that are easier to break during pulping at lower temperatures (Akpan, E. I. Chemistry and Structure of Lignin. In Sustainable Lignin for Carbon Fibers: Principles, Techniques, and Applications; Springer Cham: Gateway East, Singapore, 2019; pp. 1-50. ISBN 9783030187927). CS and RCG, being less recalcitrant, showed a more extensive delignification under the mild pulping conditions. These outcomes are in accordance with previous studies from the literature, where Joachimiak et al. compared the pulping yields and delignification degree of a hardwood biomass (Birch sawdust) with that of a grass (Miscanthus stems) (Joachimiak, K. et al., Wood Res. 2019, 64, 49-58). Under the same pulping conditions, the grass displayed much higher and faster delignification than the hardwood, which was attributed to chemical and morphological differences between the two feedstocks.

After PAA pretreatment, all feedstocks displayed a trend of further delignification accompanied by minor carbohydrate losses, comparable to previous studies employing PAA treatments on different feedstocks (Kundu, C. et al., Sci. Rep. 2021, 11, 11183; Kumar, R. et al., Bioresour. Technol. 2013, 130, 372-81; Wi, S. G. et al., Biotechnol. Biofuels 2015, 8, 1-11). These results demonstrate the high selectivity of PAA toward lignin and the process's capacity to preserve high amounts of holocellulose (>60%) in the fibers. Generally, acid treatments cause extensive solubilization of the hemicellulose fraction from the fibers (Carvalheiro, F. et al., J. Sci. Ind. Res. 2008, 67, 849-64), lowering yields. In contrast, the mild PAA pretreatment used in this work successfully preserved hemicellulose in the final fibers, as seen by the presence of arabinan, galactan, xylan, and mannan in their composition (Supporting Information, Table S3). The recovery of hemicellulose in the final fibers is advantageous because it increases the total mass yields and provides unique properties to the final product.

Compared to the untreated biomass, both CS and RCG had lower lignin recoveries (5-7%), while IH still retained 28% of the original lignin in its composition (FIG. 14B). These results reiterate that IH lignin is more difficult to remove than that of CS and RCG under the same mild reaction conditions, even in the presence of oxidizing chemicals such as PAA. Due to its higher residual lignin content, IH PAA-treated pulp presented a yellow-toned color. By increasing the amount of chemicals during PAA pretreatment of IH by 10×, a more substantial delignification was achieved (with up to 94% lignin removal), reaching similar recoveries to those obtained for CS and RCG under milder PAA dosages (FIG. 14B). This improvement in delignification at higher PAA charges is consistent with previous reports in the literature, where increased PAA concentration during a bleaching reaction at pH 5 improved the whiteness index (indicating a lower lignin content) of IH pulp (Gedik, G. et al., Fibers Polym. 2018, 19, 82-93). Interestingly, the tenfold increase in PAA chemical load mainly affected the lignin content (as seen by a 22% difference in the lignin recovery of IH 10× compared to IH), while only minor variations were observed in holocellulose (<5% difference). This outcome shows that the lignin component is more sensitive to changes in PAA load than the carbohydrates (Lyu, Q. et al., Bioresour. Technol. 2021, 320, 124306), which may again be attributed to high PAA selectivity toward lignin.

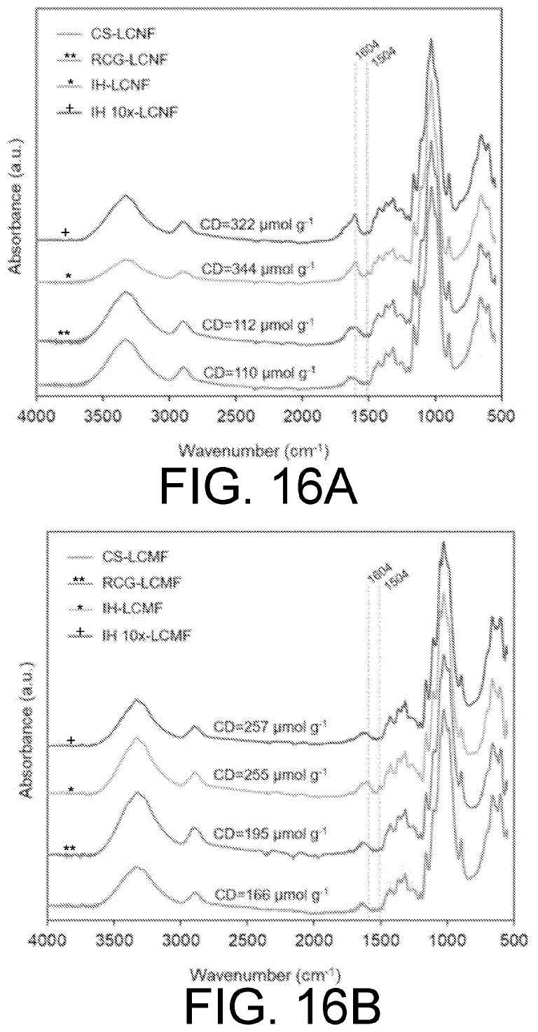

FIG. 15 illustrates examples of optical transmittance spectra of different lignocellulosic nanofibers suspensions. FIG. 15 shows the complete light transmittance spectra of LCMF and LCNF suspensions obtained after the mechanical fibrillation and homogenization of PAA-treated pulps. The mild process utilized in this study successfully produced gel-like suspensions of LCNF and LCMF from the feedstocks tested. As seen in FIG. 15, the LCNF fractions exhibited high light transmittance values (83-88% at 660 nm), demonstrating the presence of very tiny nanofibrils, while the LCMF fractions showed a milky-white appearance and low transmittance values (3-8%) due to higher light scattering by the presence of larger fibrils (Espinosa, E. et al., Cellulose 2017, 24, 2605-18; Oliaei, E. et al., Cellulose 2020, 27, 2325-41). In addition, the LCNFs and LCMFs demonstrated good colloidal stability regardless of the feedstock type. This may be associated with the presence of hemicellulose heteropolysaccharides, as indicated by the arabinan, galactan, xylan, and mannan analyses in Table 7:

TABLE 7
Relative carbohydrate composition in holocellulose of
untreated biomass, alkaline peroxide pulps, and PAA
treated pulps of the different biomass feedstocks

| | | Arabinan | Galactan | Glucan | Xylan | Mannan |
|---|---|---|---|---|---|---|
| | | (%) | (%) | (%) | (%) | (%) |
| Untreated | CS | 3.4 | 1.1 | 58.5 | 37.0 | 0.0 |
| | RCG | 5.7 | 2.5 | 60.7 | 31.0 | 0.0 |
| | IH | 2.3 | 3.5 | 70.8 | 21.2 | 2.2 |
| Pulp | CS | 2.3 | 0.4 | 64.7 | 32.6 | 0.0 |
| | RCG | 5.3 | 1.4 | 62.7 | 30.6 | 0.0 |
| | IH | 0.7 | 1.7 | 72.3 | 23.6 | 1.6 |
| PAA- | CS | 2.3 | 0.3 | 66.1 | 31.4 | 0.0 |
| Treated | RCG | 2.4 | 0.5 | 69.7 | 27.4 | 0.0 |
| | IH | 0.3 | 0.9 | 71.8 | 25.7 | 1.3 |
| | IH 10× | 0.3 | 0.8 | 72.1 | 24.6 | 2.2 |

Hemicellulose is known to promote colloidal stability through steric hindrance and Coulombic repulsion (Solala, I. et al., Cellulose 2020, 27, 1853-77). IH LCNF and IH LCMF presented lower transmittance values across the entire spectra (FIG. 3) as a result of their higher residual lignin content (12%) compared to the other samples (2-4%) (Table 6). Lignin is well known to have relatively strong light absorption (Oliaei, E. et al., Cellulose 2020, 27, 2325-41).

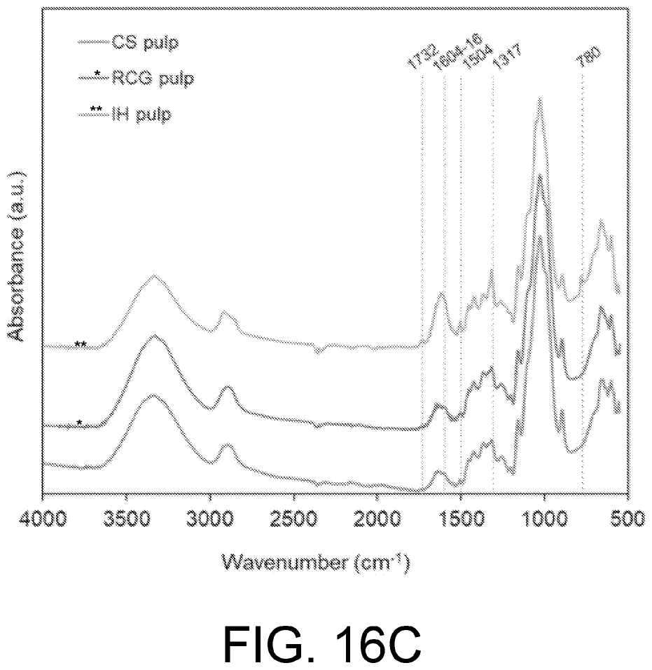

FIGS. 16A to 16C illustrate FTIR spectra showing specific chemical bonds of LCNFs (FIG. 16A), and LCMFs (FIG. 16B), and pulps (FIG. 16C) of different biomass feedstocks. CD values obtained via conductometric titration are also shown.

FIGS. 16A and 16B show FTIR spectra with specific bonds of LCNF (FIG. 16A) and LCMF (FIG. 16B) fractions obtained from each feedstock, along with the charge density (CD) values obtained by conductometric titration. It can be seen that both LCNFs produced from IH presented higher CD values (322-344 μmol g⁻¹) than those from CS and RCG (110-112 μmol g⁻¹) (FIG. 16A). A similar trend was observed for LCMFs produced from IH, but to a lower extent (FIG. 16B).

The higher CD values for IH products were further verified by the presence of a more prominent peak at 1604 cm⁻¹ in FTIR spectra of both IH-LCNF and IH 10×-LCNF compared to that of CS and RCG. The band at 1604 cm⁻¹ has been previously associated with carboxyl groups present in hemicellulose (Zhuang, J. et al., Appl. Sci. 2020, 10, 4345; Gandolfi, S. et al., BioResources 2013, 8, 2641-56) that promote a negative surface charge to the fibers. Furthermore, the peak at 1504 cm⁻¹ corresponding to C═C stretching vibration of lignin aromatic rings (Li, X. et al., Biotechnol. Biofuels 2018, 11, 1-16) was more prominent in the IH-LCNF and IH-LCMF samples, which agrees well with the higher residual lignin content obtained for this sample. When compared to nanofibers produced via harsher reactions such as TEMPO-mediated oxidation (usually around 1000 μmol g-1), the CD values reported in this work for CS, RCG, and IH (110-344 μmol g⁻¹) are relatively lower due to the milder oxidation reaction that occurs during PAA pretreatment. CD largely improves nanofibrillation by promoting Coulombic repulsion forces between the fibers, hence the high efficacy of TEMPO oxidation in producing very small nanofibers (Saito, T. et al., Biomacromolecules 2007, 8, 2485-91). Interestingly, despite the low CD values obtained in this work, LCNFs of comparable morphology to those obtained via harsher TEMPO oxidation were obtained by means of milder and greener treatments. This outcome can be attributed to the high hemicellulose preservation achieved after both pulping and PAA pretreatment reactions, as previously discussed, and this biopolymer's unique steric hindrance capabilities (Solala, I. et al., Cellulose 2020, 27, 1853-77; Chaker, A. et al., Cellulose 2013, 20, 2863-75).

To further elucidate the origin of the higher CD of both products made from IH biomass, FTIR spectra of the pulps after alkaline peroxide pulping (before PAA pre-treatment) were also collected (FIG. 16C). This additional data demonstrates whether the carboxyl groups in IH products mainly originated during the oxidation reaction of PAA pre-treatment or came from the original biomass. Interestingly, IH pulp showed a more prominent peak at 1604-16 cm⁻¹ (which overlaps with water around 1630 cm-1) associated with the carboxyl groups of glucuronic acid in hemicellulose (Zhuang, J. et al., Appl. Sci. 2020, 10, 4345; Gandolfi, S. et al., BioResources 2013, 8, 2641-56). In addition, the peaks at 780 cm⁻¹ and around 1732 cm⁻¹ appeared exclusively in IH pulp, representing molecules that are inherent to this specific type of biomass. The band at 780 cm⁻¹ has been previously assigned to the carboxyl groups of hemicellulose (Lu, P., BioResources 2015, 10, 4239-51), while that around 1732 cm⁻¹ has been attributed to C═O stretching vibration of either acetyl groups present in xyloglucan (a specific type of hemicellulose present in IH biomass) (Gandolfi, S. et al., BioResources 2013, 8, 2641-56; Putnina, A. et al., Sci. J. Riga Tech. Univ. Mater. Sci. Text. Cloth. Technol. 2011, 6, 36-42; Zhao, J. et al., Bioresour. Technol. 2020, 309, 123383) or carboxylic ester groups in pectin (Dai, D. & Fan, M., Mater. Sci. Appl. 2010, 1, 336-42; Szymanska-Chargot, M. & Zdunek, A., Food Biophys. 2013, 8, 29-42). These results show that IH's higher carboxyl content, compared to CS and RCG, is mainly associated with hemicellulose acid groups and the presence of pectins. IH biomass has a high galacturonic acid content attributed to the presence of pectin molecules such as rhamnogalacturonan-I (Bag, R. et al., J. Wood Sci. 2012, 58, 493-504; Petit, J. et al., Front. Plant Sci. 2019, 10, 959). Correspondingly, the untreated IH biomass used in this study showed higher acetyl/uronic acids content (5.5%) compared to the other untreated feedstocks (3.1-3.8%) (Table 6), confirming the presence of pectin substances in IH. Therefore, the higher CD obtained for LCNF and LCMF from IH may be attributed to IH biomass's inherent hemicellulose and pectin compounds, with some posterior intensification during the oxidation reactions from PAA pretreatment.

Finally, the FTIR peak at 1317 cm-1 has been assigned to C—O stretching of C5 substituted aromatic rings, such as syringyl and condensed guaiacyl units of lignin (Zhuang, J. et al., Appl. Sci. 2020, 10, 4345; Gandolfi, S. et al., BioResources 2013, 8, 2641-56). Although this peak is present for all three specimens, it is more prominent in IH-derived materials as a result of IH pulp's higher lignin content (19%) compared to CS and RCG pulps (6 and 10%, respectively) (Table 6).

TABLE 8
Separation yields of LCNF and LCMF fractions after centrifugation
and their structural and morphological characteristics (CI,
fibril width and length, and fibril aspect ratio).

| | | | | Fibril | Fibril | Fibril |
|---|---|---|---|---|---|---|
| | | Separation | CI | Width | Length | Aspect |
| | | Yield (%) | (%) | (nm) | (μm) | Ratio |
| | CS | 30 | 71 | 2.1 ± 0.7 | 1.2 ± 0.7 | 585 |
| LCNF | RCG | 34 | 66 | 2.3 ± 1.4 | 1.4 ± 0.9 | 591 |
| | IH | 27 | 64 | 2.4 ± 0.9 | 1.4 ± 0.8 | 599 |
| | IH 10× | 25 | 66 | 2.8 ± 1.2 | 1.6 ± 1.2 | 565 |
| | CS | 70 | 72 | 16.9 ± 5.1 | — | — |
| LCMF | RCG | 66 | 69 | 14.3 ± 3.4 | — | — |
| | IH | 73 | 72 | 18.0 ± 12.3 | — | — |
| | IH 10× | 75 | 75 | 15.9 ± 9.3 | — | — |

Table 8 summarizes the separation yields of lignocellulosic nanofibers (LCNFs and LCMFs) after centrifugation and their structural and morphological characteristics, as determined by XRD, AFM, and SEM (i.e., crystallinity index, fibril width and length, and fibril aspect ratio). As seen in Table 8, similar product yields and morphology were obtained despite widely different feedstocks. Equivalent amounts of LCNF and LCMF fractions were obtained from all feedstocks, with LCNF yields ranging from 25-34% (and corresponding LCMF yields of 66-75%), demonstrating the unique feedstock-flexibility trait of the process. Among the three biomass feedstocks tested, IH and IH 10× samples had the lowest LCNF yields (27 and 25%, respectively), with correspondingly the highest LCMF yields (73% and 75%), suggesting the lower effectiveness of the mechanical treatments on IH biomass. Interestingly, the lignin content seemed to not play a crucial role in the extent of nanofibrillation of IH, as both IH and IH 10× resulted in comparable LCNF/LCMF separation yields. Remarkably, varying lignin contents between 3-12% (Table 6) did not affect the extent of the release of nanofibrils from IH in the present process.

The lower LCNF yields of samples prepared from IH compared to CS and RCG demonstrate a lower degree of nanofibrils released from the bigger fibrils in the original hierarchical structure of IH. This outcome results from the physical structure of IH biomass, which includes bast and core fibers. Bast fibers are incredibly long, about 25 mm in length (as a comparison, softwood cells are about 3.5 mm in length), while core fibers have similar physical characteristics as hardwoods, being 0.8 mm in length (Correia, F. et al., J. Wood Chem. Technol. 2001, 21, 97-111). The diverse fiber sizes present in untreated IH biomass possibly reduced the effectiveness of the mechanical treatment, resulting in incomplete fibrillation and lower LCNF yields. The CI of the different lignocellulosic nanofibers is also included in Table 1. Little difference was observed between the CI of LCNF and LCMF fractions produced from the various biomass feedstocks (from 64% to 75%).

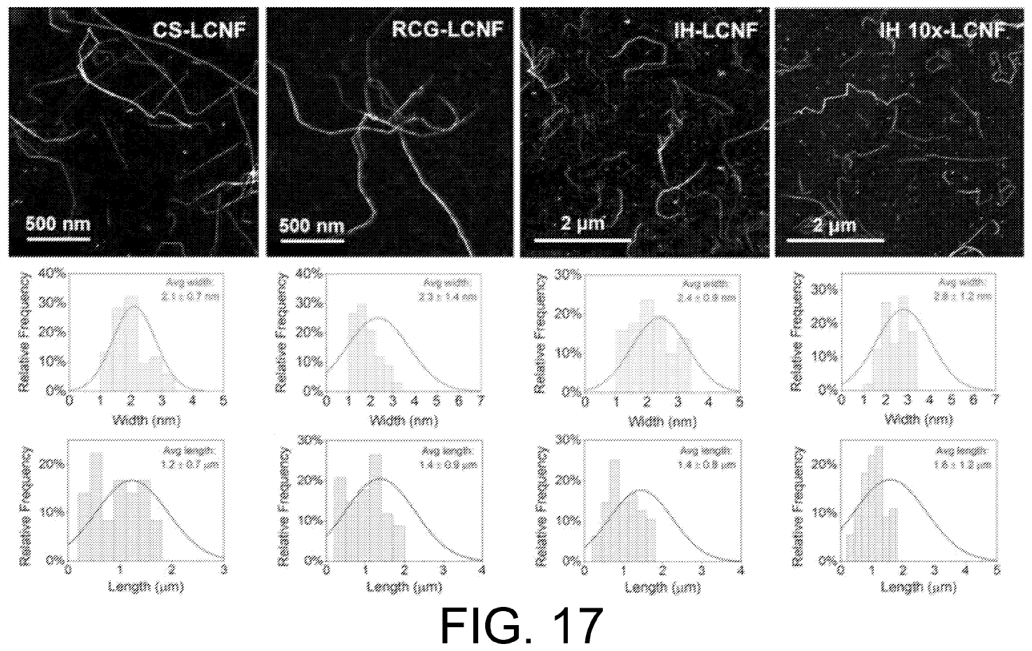

FIG. 17 illustrates examples of AFM images and size distribution curves of LCNF from different biomass feedstocks. Surprisingly, despite their different lignin contents, both IH-LCNF and IH 10×-LCNF also had comparable LCNF morphologies, showing that lignin content did not have an effect on the morphology of the LCNF fraction obtained from IH biomass.

The morphology of the LCNF fractions generated from different biomass feedstocks was examined by AFM imaging (FIG. 17), and the fibril dimensions are listed in Table 8. Representative AFM images revealed that all LCNFs had the morphology of elementary fibrils, with average widths ranging from 2.1 to 2.8 nm and lengths ranging from 1.2 to 1.6 μm. These similar morphological characteristics yielded LCNFs with comparable aspect ratios (565-599) regardless of the nature of the feedstock (Table 8). In addition, the LCNFs obtained in this study presented sizes corresponding to nanofibrils prepared from high-purity hardwood pulp feedstock via harsher TEMPO oxidation pretreatment (Saito, T. et al., Biomacromolecules 2007, 8, 2485-91). These results demonstrate the effectiveness of the present process in producing high quality LCNFs from a wide range of waste feedstocks and using milder reactions.

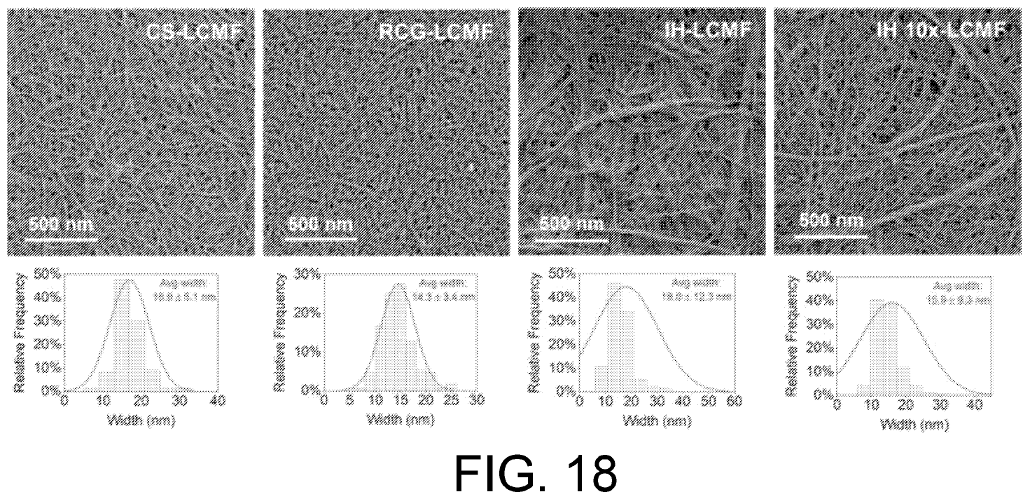

FIG. 18 illustrates examples of SEM images and size distribution curves of LCMF from different biomass feedstocks. The morphology of the LCMF fractions was characterized by SEM imaging, and the fibril widths are included in Table 8. CS and RCG feedstocks produced more uniform LCMFs than IH. IH-LCMF and IH 10×-LCMF presented several fibril bundles, supporting the above interpretation of incomplete fibrillation during IH processing, and, therefore, resulted in the highest average widths and the broadest standard deviations (Table 8). LCMFs produced from IH also presented broader, right-skewed width distribution curves than those produced from CS and RCG. Interestingly, IH 10×-LCMF had a lower standard deviation than IH-LCMF, indicating that a lower lignin content reduced the occurrence of partially fibrillated fibrils in the LCMF fraction. Overall, the average width of the LCMFs produced in this study ranged between 14 and 18 nm independent of the type of feedstock used. The obtained fiber size is comparable to other lignocellulosic nanofibers prepared from various feedstocks and processes, where reported fiber widths varied from 6 nm up to around 100 nm, with most cases applying to the 10-30 nm range (Liu, K. et al., Green Chem. 2021, 23, 9723-46). Particularly, the LCMFs produced from IH biomass exhibited a more heterogeneous size distribution comprising individual microfibrils and bundles.

The present study demonstrates that lignocellulosic nanofibers may be successfully produced from CS, RCG, and IH via similar conversion processes using mild conditions. The process was proven robust, generating products with similar morphologies despite widely different feedstocks and offering a practical pathway to manufacture lignocellulosic nanofibers from other agricultural waste biomass such as WS, rice straw, rice husk, sugarcane bagasse, and switchgrass for example. This work also reported how the feedstocks' physico-chemical characteristics influenced the final nanofibers' properties. A feedstock with physical characteristics similar to woody materials (IH in this study) was more difficult to delignify under the mild reaction conditions, resulting in nanofibers with higher lignin recovery (28% recovery) compared to other feedstocks (5-7%); but increasing the chemical loading during PAA pretreatment resulted in higher delignification of IH (6% lignin recovery) with minor carbohydrate loss. IH's unique physical structure (comprising bast and core fibers of vastly different sizes) also affected the efficacy of the mechanical treatment step, impacting the nanofibers' separation yields and morphology. Finally, feedstocks with large amounts of glucuronic acids in hemicellulose and/or pectins produced nanofibers with greater anionic surface charge (up to three times higher charge density than from other feedstocks).

Ultimately, using waste biomass feedstocks instead of bleached pulp enables engineering of the nanofiber properties due to the presence of cellulose, hemicellulose, and lignin, where each can provide distinctive properties to the final product. Nature's inherent characteristics can be used to generate nanofibers with specific properties instead of expensive post-processing surface modification reactions. The present process also allows for customization of the nanofiber properties by tuning the reaction condition parameters. In the long run, using low-cost waste feedstocks can provide substantial economic and sustainability benefits to nanocellulose production, presenting a significant stride toward large-scale production and commercialization for various applications.

### EXAMPLE CLAUSES

1. A method including: generating a first material by performing alkaline peroxide pulping on heterogenous biomass; generating a second material by removing at least a portion of a dissolved lignin fraction from the first material; generating a third material by performing mechanical fibrillation on the second material; generating a fourth material by performing a an oxidation pretreatment on the third material; and generating a fifth material including lignocellulosic microfibers (LCMF) and/or lignocellulosic nanofibers (LCNF) by performing mechanical fibrillation on the fourth material, the LCMF having a width in a range of about 10 to about 1,000 nanometers (nm), the LCNF having a width in a range of about 1 to about 10 nm.

2. The method of clause 1, wherein the heterogenous biomass includes: cellulose; and at least one of hemicellulose, lignin, ash, or an organic extractive.

3. The method of clause 1 or 2, wherein the heterogenous biomass includes at least one of leaves or stalks of a plant.

4. The method of one of clauses 1 to 3, wherein the biomass includes agricultural residues or other lignocellulosic biomass.

5. The method of clause 4, wherein the biomass includes at least one of wheat straw, sugar cane bagasse, rice straw, rice husk, corn stover, hemp, reed canary grass, switchgrass, poplar, spruce, or paper.

6. The method of one of clauses 1 to 5, wherein performing the alkaline peroxide pulping includes: generating a mixture by mixing the biomass with an alkaline peroxide solution at a liquid-to-biomass ratio between about 4:1 and about 15:1; heating the mixture at a temperature between about 60 degrees C. and about 100 degrees C. for a time interval; and quenching the mixture.

7. The method of one of clauses 1 to 6, wherein the alkaline peroxide solution includes: water; about 10 weight % to about 20 weight % sodium hydroxide, potassium hydroxide, or ammonium hydroxide; about 5 weight % to about 10 weight % hydrogen peroxide; and about 0.10 weight % to about 0.20 weight % of a chelating agent.

8. The method of clause 7, wherein the chelating agent includes DTPA and/or EDTA.

9. The method of one of clauses 1 to 8, wherein removing at least a portion of a dissolved lignin fraction from the first material includes filtering a fluid including the dissolved lignin fraction from the second material.

10. The method of clause 9, further including: recovering a lignin precipitate by: generating a slurry by mixing the fluid with an acid solution; dewatering the slurry; and drying the lignin precipitate.

11. The method of one of clauses 1 to 10, further including: washing the second material with water.

12. The method of one of clauses 1 to 11, wherein performing the mechanical fibrillation on the second material includes fibrillating the second material and water at a consistency between about 1% and 15%.

13. The method of clause 12, wherein the fibrillating is performed by a blender, hydrapulper, or a mechanical refiner.

14. The method of one of clauses 1 to 13, wherein performing the mechanical fibrillation on the second material further includes: refining the second material and the water at a consistency between about 1% and about 15%; and in response to refining the second material and the water, generating the third material by filtrating the second material.

15. The method of one of clauses 1 to 14, wherein performing the oxidation pretreatment includes: generating a mixture by mixing the third material and an oxidation solution; heating the mixture at a temperature between about 60 degrees C. and about 100 degrees C. for a time interval; and quenching the mixture.

16. The method of clause 15, wherein the oxidation solution includes about 1 weight % to about 5 weight % of an oxidizing agent, the oxidation solution having a pH between about 4 and about 5.5.

17. The method of clause 15 or 16, wherein the oxidizing agent includes at least one of peracetic acid (PAA), hydrogen peroxide, performic acid, ozone, potassium permanganate, orchlorine dioxide.

18. The method of one of clauses 15 to 17, wherein generating the mixture includes mixing the third material and the oxidation solution at a consistency between about 1% and about 10%.

19. The method of one of clauses 15 to 18, further including: washing the mixture with at least one of a caustic solution or water.

20. The method of clause 19, wherein the caustic solution includes sodium hydroxide, ammonium hydroxide, or potassium hydroxide.

21. The method of one of clauses 15 to 20, the mixture being a first mixture, the oxidation solution being a first oxidation solution, the temperature being a first temperature, the time interval being a first time interval, wherein generating the fourth material by performing the oxidation pretreatment on the third material further includes: in response to quenching the first mixture, generating a second mixture by mixing the first mixture and a second oxidation solution; heating the second mixture at a second temperature between about 60 degrees C. and about 100 degrees C. for a second time interval; and quenching the second mixture.

22. The method of clause 21, wherein the biomass includes hemp.

23. The method of clause 21 or 22, wherein generating the second mixture includes mixing the first mixture and the second oxidation solution at a consistency between about 1% to about 5%.

24. The method of one of clauses 21 to 23, wherein generating the first mixture includes mixing the third material and the first oxidation solution at a first consistency, and wherein generating the second mixture includes mixing the first mixture and the second peroxide solution at a second consistency, the second consistency being lower than the first consistency.

25. The method of one of clauses 21 to 24, wherein the second oxidation solution includes a greater weight percentage of an oxidizing agent than the first peroxide solution.

26. The method of one of clauses 21 to 25, wherein the second oxidation solution includes about 3 weight % to about 7 weight % PAA and/or hydrogen peroxide.

27. The method of one of clauses 1 to 26, wherein mechanically fibrillating the fourth material includes: fibrillating the fourth material at a consistency between about 0.2 weight % to about 1.0 weight %.

28. The method of one of clauses 1 to 27, further including: homogenizing the fifth material.

29. The method of clause 28, wherein homogenizing the fifth material includes performing microfluidization, high pressure-homogenization, and/or sonication of the fifth material.

30. The method of one of clauses 1 to 29, further including: generating a composite by casting the fifth material with polyvinyl alcohol (PVA).

31. The fourth material generated by the method of one of clauses 1 to 30.

32. The fifth material generated by the method of one of clauses 1 to 30.

33. A method including: generating a pulp by performing alkaline peroxide pulping on heterogenous biomass; and isolating lignin from the pulp by removing at least a portion of a dissolved lignin fraction from the pulp.

34. A method of generating a composite, the method including: generating a first material by performing alkaline peroxide pulping on heterogenous biomass, the heterogenous biomass including at least one of wheat straw, sugar cane bagasse, rice straw, rice husk, corn stover, hemp, reed canary grass, switchgrass, poplar, or spruce; generating a second material by removing at least a portion of a dissolved lignin fraction from the first material; generating a third material by performing mechanical fibrillation on the second material; generating a fourth material by performing a peracetic acid (PAA) pretreatment on the third material, the PAA treatment including mixing the third material with a PAA solution at a temperature in a range of about 80 to about 90 degrees C., the PAA solution having a pH in a range of about 4 to about 5.5; generating a fifth material by performing mechanical fibrillation on the fourth material; generating a sixth material by microfluidizing or sonicating the fifth material, the sixth material including lignocellulosic microfibers (LCMF) and/or lignocellulosic nanofibers (LCNF), the LCMF having a dimension in a range of about 10 to about 1,000 nanometers (nm), the LCNF having a dimension in a range of about 1 to about 10 nm; and generating a seventh material by casting a mixture including: polyvinyl alcohol (PVA); and about 1 weight % to about 10 weight % the sixth material.

35. The method of clause 34, wherein the PAA solution includes about 1 weight % to about 5 weight % PAA.

36. The method of clause 34 or 35, wherein generating the sixth material further includes: in response to microfluidizing or sonicating the fifth material, generating a supernatant and precipitate by centrifuging the fifth material, the supernatant including the LCNF and the precipitate including the LCMF.

37. A method, including: generating a treated material by performing a peracetic acid (PAA) treatment on refined pulp; generating a fibrillated material by performing mechanical fibrillation on the first material; and generating LCMF and/or LCNF by homogenizing the fibrillated material.

38. A composition including: LCMF having a width in a range of about 10 to about 1,000 nm; and/or LCNF having a width in a range of about 1 to about 10 nm.

39. The composition of clause 38, wherein the LCMF and/or LCNF include: about 60 weight % to about 98 weight % cellulose; about 1 weight % to about 25 weight % hemicellulose; and about 1 weight % to about 15 weight % lignin.

40. A composition including: about 1 weight % to about 10 weight % nanocellulose, the nanocellulose including LCMF and/or LCNF; and about 99 weight % to about 90 weight % polyvinyl alcohol (PVA).

41. The composition of clause 40, wherein the nanocellulose includes at least one of cellulose, hemicellulose, or lignin.

42. The composition of clause 40 or 41, wherein the nanocellulose includes: about 60 weight % to about 98 weight % cellulose; about 1 weight % to about 25 weight % hemicellulose; and about 1 weight % to about 15 weight % lignin.

43. A system configured to generate a composition, the system including: a vessel configured to receive refined pulp and a peracetic acid (PAA) solution; a mixer configured to mix the refined pulp and the PAA solution in the vessel; a heater configured to maintain an internal temperature of the vessel in a range between 60 degrees C. and about 100 degrees C. during a reaction that generates a PAA pretreated pulp from the refined pulp and the PAA solution; a washer configured to wash the PAA pretreated pulp; and a mechanical fibrillator configured to generate a product by performing mechanical fibrillation on the PAA pretreated pulp, the product including LCMF and/or LCNF.

44. The system of clause 43, wherein the PAA solution includes about 1 weight % to about 5 weight % PAA, the PAA solution having a pH between about 4 and about 5.5.

45. The system of clause 43 or 44, wherein the mechanical fibrillator includes a blender, a hydrapulper, or a mechanical refiner.

46. The system of one of clauses 43 to 45, further including: a stirred reactor configured to receive biomass and an alkaline peroxide solution; and a mill configured to receive the biomass from the stirred reactor and to generate the refined pulp by milling an output of the stirred reactor.

47. The system of clause 46, wherein the alkaline peroxide solution includes water, about 10 weight % to about 20 weight % sodium hydroxide, potassium hydroxide, or ammonium hydroxide, about 5 weight % to about 10 weight % hydrogen peroxide, and about 0.10 weight % to about 0.20 weight % DTPA.

48. The system of one of clauses 43 to 47, further including: a centrifuge configured to generate a supernatant and a precipitate from the product, the supernatant including the LCNF, the precipitate including the LCMF.

49. The system of one of clauses 43 to 47, further including: a homogenizer configured to homogenize the product.

50. The system of clause 49, wherein the homogenizer includes a microfluidizer, high-pressure homogenizer, or a sonicator.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

This document refers to numerous articles, books, printed publications, and other references. Each one of these references is hereby incorporated by reference.

1. A method, comprising:
generating a first material by performing alkaline peroxide pulping on heterogenous biomass;
generating a second material by removing at least a portion of a dissolved lignin fraction from the first material;
generating a third material by performing mechanical fibrillation on the second material;
generating a fourth material by performing an oxidation pretreatment on the third material; and
generating a fifth material comprising lignocellulosic microfibers (LCMF) and/or lignocellulosic nanofibers (LCNF) by performing mechanical fibrillation on the fourth material, the LCMF having a width in a range of about 10 to about 1,000 nanometers (nm), the LCNF having a width in a range of about 1 to about 10 nm.

2-5. (canceled)

6. The method of claim 1, wherein performing the alkaline peroxide pulping comprises:
generating a mixture by mixing the heterogenous biomass with an alkaline peroxide solution at a liquid-to-biomass ratio between about 4:1 and about 15:1;
heating the mixture at a temperature between about 60 degrees C. and about 100 degrees C. for a time interval; and
quenching the mixture.

7. The method of claim 1, wherein performing the alkaline peroxide pulping comprises:
generating a mixture by mixing the heterogenous biomass with an alkaline peroxide solution, and
wherein the alkaline peroxide solution comprises:
water;
about 10 weight % to about 20 weight % sodium hydroxide, potassium hydroxide, or ammonium hydroxide;
and
about 0.10 weight % to about 0.20 weight % of a chelating agent, the chelating agent comprising diethylenetriaminepentaacetic acid (DTPA) and/or ethylenediaminetetraacetic acid (EDTA).

8-9. (canceled)

10. The method of claim 1, wherein removing at least the portion of the dissolved lignin fraction from the first material comprises filtering a fluid comprising the dissolved lignin fraction from the second material, the method further comprising:
recovering a lignin precipitate by:
generating a slurry by mixing the fluid with an acid solution;
dewatering the slurry; and
drying the lignin precipitate.

11-13. (canceled)

14. The method of claim 1, further comprising:
washing the second material with water,
wherein performing the mechanical fibrillation on the second material further comprises:
refining the second material and water at a pulp consistency between about 1% and about 15%; and
in response to refining the second material and the water, generating the third material by filtrating the second material.

15. The method of claim 1, wherein performing the oxidation pretreatment comprises:
generating a mixture by mixing the third material and an oxidation solution at a pulp consistency between about 1% and about 10%;
heating the mixture at a temperature between about 60 degrees C. and about 100 degrees C. for a time interval; and
quenching the mixture, and
wherein the oxidation solution comprises about 1 weight % to about 5 weight % of an oxidizing agent, the oxidation solution having a pH between about 4 and about 5.5, the oxidizing agent comprising at least one of peracetic acid (PAA), hydrogen peroxide, performic acid, ozone, potassium permanganate, or chlorine dioxide.

16-18. (canceled)

19. The method of claim 15, further comprising:
washing the mixture with at least one of a caustic solution or water, the caustic solution comprising sodium hydroxide, ammonium hydroxide, or potassium hydroxide.

20-26. (canceled)

27. The method of claim 1, wherein mechanically fibrillating the fourth material comprises: fibrillating the fourth material at a pulp consistency between about 0.2 weight % to about 1.0 weight %.

28. The method of claim 1, further comprising:
homogenizing the fifth material by performing microfluidization, high pressure-homogenization, and/or sonication of the fifth material; and/or
generating a supernatant and precipitate by centrifuging the fifth material, the supernatant comprising the LCNF and the precipitate comprising the LCMF.

29. (canceled)

30. The method of claim 1, further comprising:
generating a composite by casting the fifth material with polyvinyl alcohol (PVA).

31-33. (canceled)

34. A method of generating a composite, the method comprising:
generating a first material by performing alkaline peroxide pulping on heterogenous biomass, the heterogenous biomass comprising at least one of wheat straw, sugar cane bagasse, rice straw, rice husk, corn stover, hemp, reed canary grass, switchgrass, poplar, or spruce;
generating a second material by removing at least a portion of a dissolved lignin fraction from the first material;
generating a third material by performing mechanical fibrillation on the second material;
generating a fourth material by performing a PAA pretreatment on the third material, the PAA pretreatment comprising mixing the third material with a PAA solution at a temperature in a range of about 80 to about 90 degrees C., the PAA solution having a pH in a range of about 4 to about 5.5;
generating a fifth material by performing mechanical fibrillation on the fourth material;
generating a sixth material by microfluidizing or sonicating the fifth material, the sixth material comprising LCMF and/or LCNF, the LCMF having a dimension in a range of about 10 to about 1,000 nanometers (nm), the LCNF having a dimension in a range of about 1 to about 10 nm; and
generating a seventh material by casting a mixture comprising:
PVA;
about 1 weight % to about 10 weight % the sixth material.

35. The method of claim 34, wherein the PAA solution comprises about 1 weight % to about 5 weight % PAA.

36. The method of claim 34, wherein generating the sixth material further comprises:
in response to microfluidizing or sonicating the fifth material, generating a supernatant and precipitate by centrifuging the fifth material, the supernatant comprising the LCNF and the precipitate comprising the LCMF.

37-42. (canceled)

43. A system configured to generate a composition, the system comprising:
a vessel configured to receive refined pulp and a PAA solution;
a mixer configured to mix the refined pulp and the PAA solution in the vessel;
a heater configured to maintain an internal temperature of the vessel in a range between 60 degrees C. and about 100 degrees C. during a reaction that generates a PAA pretreated pulp from the refined pulp and the PAA solution;
a washer configured to wash the PAA pretreated pulp; and
a mechanical fibrillator configured to generate a product by performing mechanical fibrillation on the PAA pretreated pulp, the product comprising LCMF and/or LCNF.

44. The system of claim 43, wherein the PAA solution comprises about 1 weight % to about 5 weight % PAA, the PAA solution having a pH between about 4 and about 5.5.

45. The system of claim 43, wherein the mechanical fibrillator comprises a blender, a hydrapulper, or a mechanical refiner.

46. The system of claim 43, further comprising:
a stirred reactor configured to receive heterogenous biomass and an alkaline peroxide solution; and
a mill configured to receive the heterogenous biomass from the stirred reactor and to generate the refined pulp by milling an output of the stirred reactor,
wherein the alkaline peroxide solution comprises water, about 10 weight % to about 20 weight % sodium hydroxide, potassium hydroxide, or ammonium hydroxide, about 5 weight % to about 10 weight % hydrogen peroxide, and about 0.10 weight % to about 0.20 weight % DTPA.

47. (canceled)

48. The system of claim 43, further comprising:
a homogenizer configured to homogenize the product, the homogenizer comprising a microfluidizer, high-pressure homogenizer, or a sonicator.

49. (canceled)

50. The system of claim 43, further comprising:
a centrifuge configured to generate a supernatant and a precipitate from the product, the supernatant comprising the LCNF, the precipitate comprising the LCMF.

51. The method of claim 7, wherein the alkaline peroxide solution comprises:
about 5 weight % to about 10 weight % hydrogen peroxide.
